(19) United States
(12) Patent Application Publication
(10) Pub. No.: US 2009/0281303 A1
(43) Pub. Date: Nov. 12, 2009

(54) PROCESS FOR SILYLATING CELLULOSE

(75) Inventors: Klemens Massonne, Bad Duerkheim (DE); Veit Stegmann, Mannheim (DE); Giovanni D'Andola, Heidelberg (DE); Werner Mormann, Siegen (DE); Markus Wezstein, Willich-Schiefbahn (DE); Wei Leng, Siegen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignees: BASF SE, Ludwigshafen (DE); UNIVERSITAET SIEGEN, Siegen (DE)

(21) Appl. No.: 12/305,391

(22) PCT Filed: Jun. 19, 2007
(86) PCT No.: PCT/EP2007/056044

§ 371 Date: Dec. 18, 2008

(30) Foreign Application Priority Data
Jun. 23, 2006 (DE) 10 2006 029 306.1
Jul. 12, 2006 (DE) 10 2006 032 569.9
Sep. 9, 2006 (DE) 10 2006 042 890.0
Nov. 15, 2006 (DE) 10 2006 054 233.9

(51) Int. Cl. C08B 1/00; C08B 37/00

(52) U.S. Cl. 536/56; 536/123.1; 536/123.13; 536/124

(57) ABSTRACT

The present invention describes a process for silylating polysaccharides, oligosaccharides or disaccharides or derivatives thereof by dissolving these in an ionic liquid and reacting them with a silylating agent.

The present invention describes a process for silylating cellulose by reacting cellulose with a silylating agent in an ionic liquid.

Cellulose is the most important renewable raw material and represents an important starting material for, for example, the textile, paper and nonwovens industries. It also serves as raw material for derivatives and modifications of cellulose, including cellulose ethers such as methylcellulose and carboxymethylcellulose, cellulose esters based on organic acids, e.g. cellulose acetate, cellulose butyrate, and cellulose esters based on inorganic acids, e.g. cellulose nitrate, silylated celluloses such as trimethylcellulose and others. These derivatives and modifications have many uses, for example in the textile, food, building and surface coatings industry. There is particular interest in, inter alia, silylated celluloses.

Silylating agents such as trialkylchlorosilanes, for example trimethylchlorosilane, hexamethyldisilazane or N,O-bis(trimethylsilyl)acetamide are usually used in the silylation of cellulose. In the case of trialkylchlorosilanes, corresponding stoichiometric amounts of an auxiliary base, e.g. pyridine, have to be added. However, owing to its poor solubility, the cellulose has to be activated in a preceding step. For this purpose, the cellulose is pretreated with ammonia, an alkylamine or mixtures thereof. The silylating agent is then added to the resulting heterogeneous systems and the silylation is carried out. A particular disadvantage here is that the reaction mixture is initially heterogeneous, goes through a homogeneous phase and generally becomes heterogeneous again at high DS values (W. Mormann, Cellulose 10, 271 (2003) and references cited therein). This phenomenon makes industrial implementation virtually impossible.

Furthermore, silylations of cellulose in dimethylacetamide/LiCl mixtures have been described. These are silylations in a homogeneous phase, but here, too, a preceding activation is necessary in order to obtain a homogeneous phase. This makes the process very complicated (W. Schempp et al., Das Papier, 38, 607 (1984)).

It was therefore an object of the invention to discover a simple process for silylating polysaccharides, in particular cellulose, in which the polysaccharide, preferably cellulose, can be converted without prior activation into the corresponding silylated product and the latter can be isolated from the reaction mixture in a simple fashion.

We have now found a process for preparing silylated polysaccharides, in particular cellulose, in which the corresponding polysaccharide is dissolved in an ionic liquid, a homogeneous solution of the polysaccharide is provided in this way and the solution is treated with a silylating agent.

For the purposes of the present invention, ionic liquids are preferably

(A) salts of the general formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;
   (B) mixed salts of the general formulae (II)

[A¹]⁺[A²]⁺[Y]ⁿ⁻ (IIa)

where n=2;

[A¹]⁺[A²]⁺[A³]⁺[Y]ⁿ⁻ (IIb)

where n=3; or

[A¹]⁺[A²]⁺[A³]⁺[A⁴]⁺[Y]ⁿ⁻ (IIc)

where n=4,
where [A¹]⁺, [A²]⁺, [A³]⁺ and [A⁴]⁺ are selected independently from among the groups mentioned for [A]⁺ and [Y]ⁿ⁻ is as defined under (A).

The ionic liquids preferably have a melting point of less than 180° C. The melting point is particularly preferably in the range from −50° C. to 150° C., in particular in the range from −20° C. to 120° C. and extraordinarily preferably below 100° C.

The ionic liquids used according to the invention are organic compounds, i.e. at least one cation or anion of the ionic liquid comprises an organic radical.

Compounds suitable for the formation of the cation [A]⁺ of ionic liquids are known, for example, from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur or oxygen atom, very particularly preferably compounds having two nitrogen atoms. Further preference is given to aromatic heterocycles.

Particularly preferred compounds have a molecular weight below 1000 g/mol, very particularly preferably below 500 g/mol and in particular below 350 g/mol.

Furthermore, preference is given to cations selected from among the compounds of the formulae (IIIa) to (IIIw),

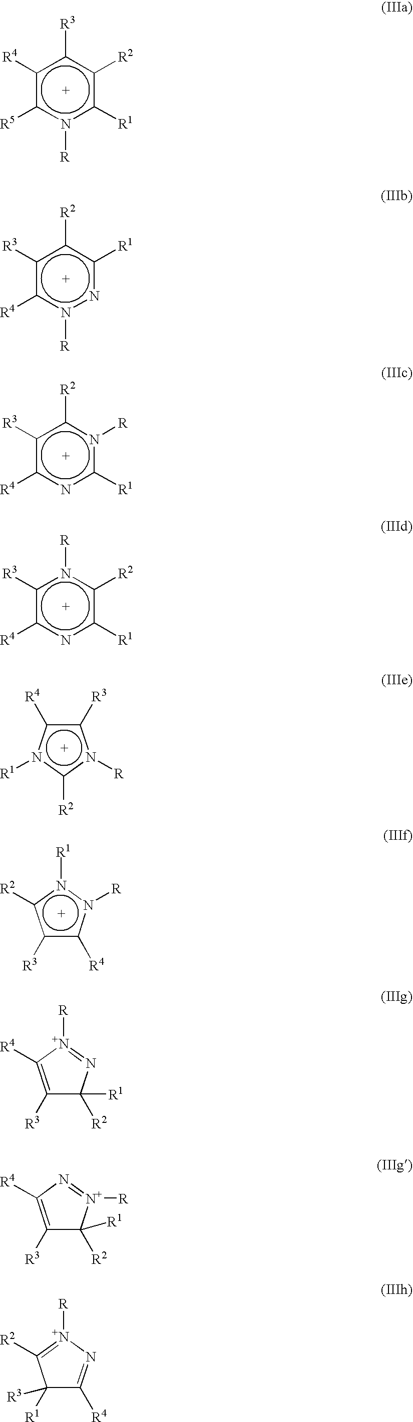

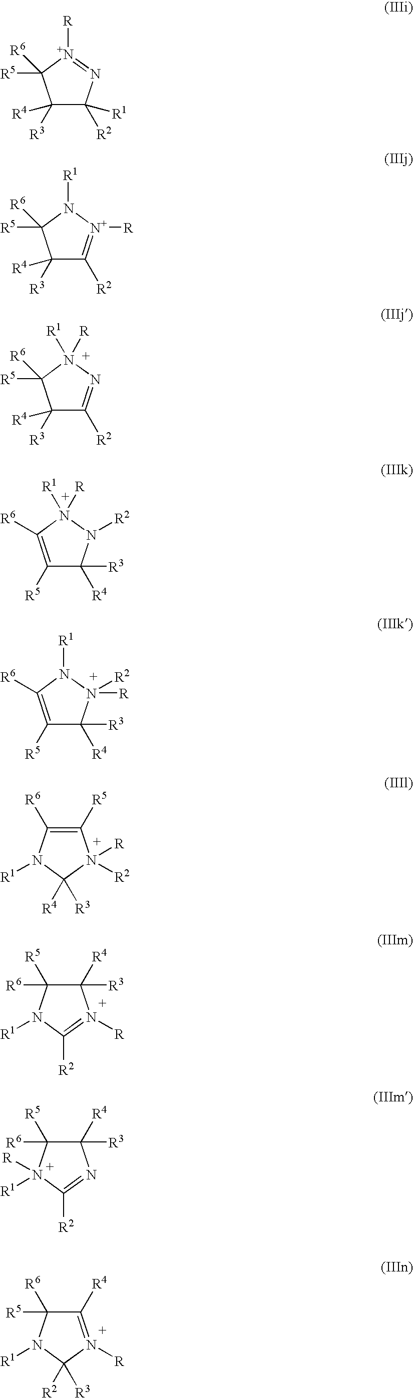

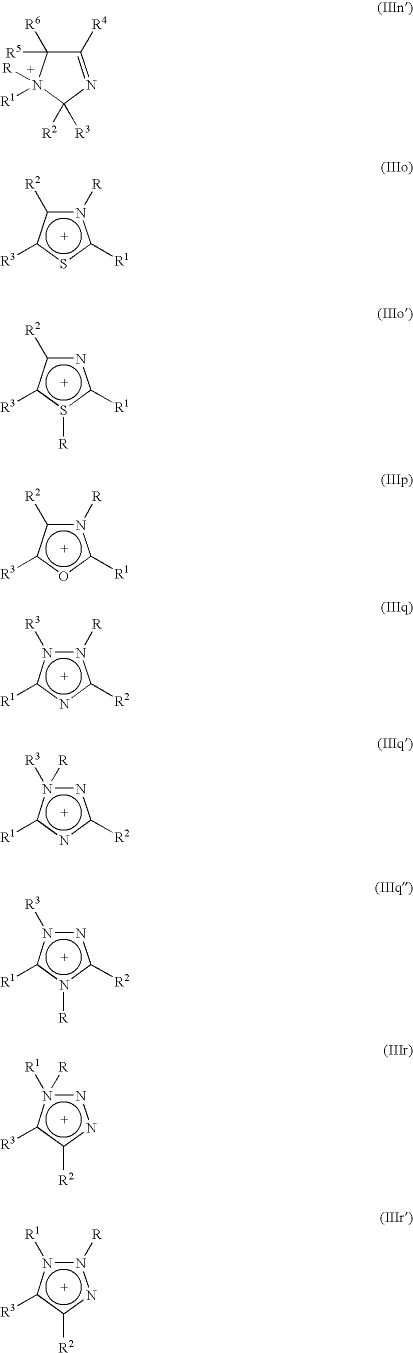

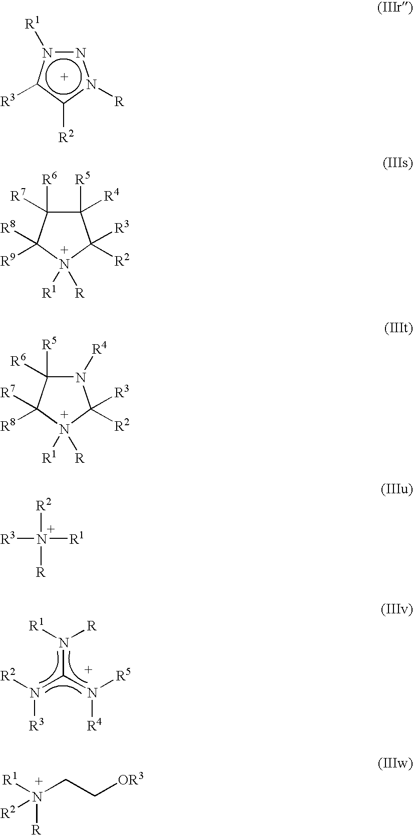

and oligomers comprising these structures.

Further suitable cations are compounds of the general formulae (IIIx) and (IIIy)

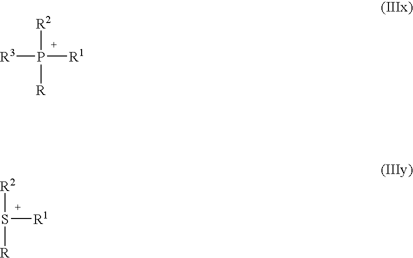

and oligomers comprising these structures.

In the abovementioned formulae (IIIa) to (IIIy),
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (II) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definitions of the radicals R and R¹ to R⁹, possible heteroatoms are in principle all heteroatoms which are able to formally replace a —CH₂— group, a —CH═ group, a —C≡ group or a ═C═ group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′—, —PR′₃ and —SiR′₂—, where the radicals R′ are the remaining part of the carbon-comprising radical. In the cases in which the radicals R¹ to R⁹ are bound to a carbon atom (and not a heteroatom) in the abovementioned formula (II), they can also be bound directly via the heteroatom.

Suitable functional groups are in principle all functional groups which can be bound to a carbon atom or a heteroatom and do not react with silylating reagents. Suitable examples are ═O (in particular as carbonyl group), —NR₂′, ═NR′, —CONH₂ (carboxamide), and —CN (cyano). Functional groups and heteroatoms can also be directly adjacent, so that combinations of a plurality of adjacent atoms, for instance —O— (ether), —S— (thioether), —COO— (ester), —CONH— (secondary amide) or —CONR′— (tertiary amide), are also comprised, for example di-(C₁-C₄-alkyl)amino, C₁-C₄-alkyl-oxycarbonyl or C₁-C₄-alkyloxy. The radicals R′ are the remaining part of the carbon-comprising radical.

As halogens, mention may be made of fluorine, chlorine, bromine and iodine.

The radical R is preferably
unbranched or branched C₁-C₁₈-alkyl which may be unsubstituted or substituted by one or more halogen, phenyl, cyano and/or C₁-C₆-alkoxy-carbonyl and/or sulfonic acid and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl; and undecylfluoroisopentyl,
glycols, butylene glycols and oligomers thereof having from 1 to 100 units, with all the above groups bearing a C₁-C₈-alkyl radical as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably methyl or ethyl and m is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, 1-propen-3-yl, in particular methyl, ethyl, 1-butyl and 1-octyl, or CH₃O—(CH₂CH₂O)ₘ—CH₂CH₂— and CH₃CH₂O—(CH₂CH₂O)ₘ—CH₂CH₂— where m is 0 to 3.

Preference is given to the radicals R¹ to R⁹ each being, independently of one another,
hydrogen;
halogen;
a suitable functional group;
C₁-C₁₈-alkyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by suitable functional groups, aryl, alkyl, aryloxy, alkyloxy, halogen, heteroatoms and/or heterocycles;
C₅-C₁₂-cycloalkyl which may optionally be substituted by suitable functional groups, aryl, alkyl, aryloxy, alkyloxy, halogen, heteroatoms and/or heterocycles;
C₅-C₁₂-cycloalkenyl which may optionally be substituted by suitable functional groups, aryl, alkyl, aryloxy, alkyloxy, halogen, heteroatoms and/or heterocycles; or
a five- or six-membered, oxygen-, nitrogen- and/or sulfur-comprising heterocycle which may optionally be substituted by suitable functional groups, aryl, alkyl, aryloxy, alkyloxy, halogen, heteroatoms and/or heterocycles; or
   two adjacent radicals together form
an unsaturated, saturated or aromatic ring which may optionally be substituted by suitable functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by suitable functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethlylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentyl-methyl, 2-cyclopentylethyl, 3-cyclopentylpropyl, cyclohexylmethyl, 2-cyclohexylethyl, 3-cyclohexylpropyl, benzyl(phenylmethyl), diphenylmethyl(benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxy-benzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-dimethylaminoethyl, 2-dimethylaminopropyl, 3-dimethylaminopropyl, 4-dimethylaminobutyl, 6-dimethylaminohexyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎₊₁F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxy-carbonyl)ethyl, butylthiomethyl, 2-dodecylthioethyl, 2-phenylthioethyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-alkenyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)}H_{2a-b} where m≦30, 0≦a≦m and b=0 or 1.

C₆-C₁₂-aryl which may optionally be substituted by suitable functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichloro-phenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitro-phenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5.

C₅-C₁₂-cycloalkyl which may optionally be substituted by suitable functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1, or a saturated or unsaturated bicyclic system such as norbornyl or norbornenyl.

C₅- to C₁₂-cycloalkenyl which may optionally be substituted by suitable functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF₂F_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by suitable functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by suitable functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more halogen, phenyl, cyano, and/or C₁-C₁₈-alkoxycarbonyl groups and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-cyanoethyl, 2-(methoxycarbonyl)ethyl, 2-(ethoxycarbonyl)ethyl, 2-(n-butoxy-carbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl and undecylfluoroisopentyl;
glycols, butylenes glycols and oligomers thereof having from 1 to 100 units, with all the above groups bearing a C₁-C₈-alkyl radical as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
vinyl;
1-propen-1-yl, 1-propen-2-yl and 1-propen-3-yl; and
N,N-di-C₁-C₆-alkylamino, such as N,N-dimethylamino and N,N-diethylamino;
   where, when IIIw is III, then R³ is not hydrogen.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— and CH₃CH₂O—(CH₂CH₂O)ₘ—CH₂CH₂— where m is 0-3.

Very particularly preferred pyridinium ions (IIIa) are those in which
one of the radicals R¹ to R⁵ is methyl, ethyl or chlorine and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R² is carboxamide and the remaining radicals R¹, R², R⁴ and R⁵ are each hydrogen; or
R¹ and R² or R² and R³ are 1,4-buta-1,3-dienylene and the remaining radicals R¹, R², R⁴ and R⁵ are each hydrogen;
   and in particular those in which
R¹ to R⁵ are each hydrogen; or
one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)-pyridinium, 1-(1-tetradecyl)pyridinium, 1-(1-hexadecyl)pyridinium, 1,2-dimethyl-pyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethyl pyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Very particularly preferred pyridazinium ions (IIIb) are those in which
R¹ bis R⁴ are each hydrogen; or
one of the radicals R¹ to R⁴ is methyl or ethyl and the remaining radicals R¹ to R⁴ are each hydrogen.

Very particularly preferred pyridinium ions (IIIc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IIId) are those in which
R¹ is hydrogen, methyl or ethyl and R² to R⁴ are each, independently of one another, hydrogen or methyl,
R¹ is hydrogen, methyl or ethyl, R² and R⁴ are each methyl and R³ is hydrogen;
R¹ to R⁴ are each methyl; or
R¹ to R⁴ are each methyl or hydrogen.

Very particularly preferred imidazolium ions (IIIe) are those in which
R² to R⁴ are each, independently of one another, hydrogen; with preference being given to R² to R⁴ each being, independently of one another, hydrogen and R and R¹ each being, independently of one another, C₁-C₄-alkyl or allyl.

Imidazolium ions (IIIe) which are likewise very particularly preferred are those in which
R³ and R⁴ are each, independently of one another, hydrogen; with preference being given to R³ and R⁴ each being, independently of one another, hydrogen and R, R¹ and R² each being, independently of one another, C₁-C₄-alkyl or allyl; and particular preference being given to R³ and R⁴ each being, independently of one another, hydrogen, R and R¹ each being, independently of one another, C₁-C₄-alkyl, and R² each being C₁-C₄-alkyl or allyl.

Imidazolium ions (IIIe) which are likewise particularly preferred are those in which
R¹ is hydrogen, methyl, ethyl, 1-propyl, 1-butyl, 1-pentyl, 1-hexyl, 1-octyl, 1-propen-3-yl or 2-cyanoethyl, and R² to R⁴ are each, independently of one another, hydrogen, methyl or ethyl.

As very particularly preferred imidazolium ions (IIIe), mention may be made of 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl)-imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-tri-methylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

Very particularly preferred pyrazolium ions (IIIf), (IIIg) and (IIIg′) are those in which
R¹ is hydrogen, methyl or ethyl and R² to R⁴ are each, independently of one another, hydrogen or methyl.

Very particularly preferred pyrazolium ions (IIIh) are those in which
R¹ to R⁴ are each, independently of one another, hydrogen or methyl.

Very particularly preferred 1-pyrazolinium ions (IIIi) are those in which
R¹ to R⁶ are each, independently of one another, hydrogen or methyl.

Very particularly preferred 2-pyrazolinium ions (IIIj) and (IIIj′) are those in which
R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IIIl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which
R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which
R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which
R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which
R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IIIs) are those in which
R¹ is hydrogen, methyl, ethyl or phenyl and R² to R⁹ are each, independently of one another, hydrogen or methyl.

Very particularly preferred imidazolidinium ions (IIIt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl or 2-cyanoethyl.

As very particularly preferred ammonium ions (IIIu), mention may be made of methyltri-(1-butyl)ammonium, N,N-dimethylpiperidinium and N,N-dimethyl-morpholinium.

Examples of tertiary amines from which the quaternary ammonium ions of the general formula (IIIu) are derived by quaternization with the radicals R mentioned are diethyl-n-butylamine, diethyl-tert-butylamine, diethyl-n-pentylamine, diethyl-hexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl-(2-ethylhexyl)amine, diisopropylethylamine, diisopropyl-n-propylamine, diisopropyl-butylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl-(2-ethylhexyl)amine, N-n-butylpyrrolidine, N-sec-butylpyrrolidine, N-tert-butyl-pyrrolidine, N-n-pentylpyrrolidine, N,N-dimethylcyclohexylamine, N,N-diethylcyclo-hexylamine, N, N-di-n-butylcyclohexylamine, N-n-propylpiperidine, N-isopropyl-piperidine, N-n-butylpiperidine, N-sec-butylpiperidine, N-tert-butylpiperidine, N-n-pentylpiperidine, N-n-butylmorpholine, N-sec-butylmorpholine, N-tert-butyl-morpholine, N-n-pentylmorpholine, N-benzyl-N-ethylaniline, N-benzyl-N-n-propyl-aniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propyl-phenylamine and di-n-butylphenylamine.

Preferred quaternary ammonium ions of the general formula (IIIu) are those which can be derived from the following tertiary amines by quaternization by means of the radicals R mentioned, e.g. diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IIIv) are those in which
R¹ to R⁵ are each methyl.

As a very particularly preferred guanidinium ion (IIIv) mention may be made of N,N,N′,N″,N″,N″-hexamethylguanidinium.

Very particularly preferred cholinium ions (IIIw) are those in which
R¹ and R² are each, independently of one another, methyl, ethyl, 1-butyl or 1-octyl and R³ is methyl, ethyl or acetyl;
R¹ is methyl, ethyl, 1-butyl or 1-octyl, R² is a —CH₂—CH₂—OR⁴ group and R³ and R⁴ are each, independently of one another, methyl, ethyl or acetyl; or
R¹ is a —CH₂—CH₂—OR⁴ group, R² is a —CH₂—CH₂—OR⁵ group and R³ to R⁵ are each, independently of one another, methyl, ethyl or acetyl.

Particularly preferred cholinium ions (IIIw) are those in which R³ is selected from among methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

Very particularly preferred phosphonium ions (IIIx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)-pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)-imidazolium, 1-(1-tetradecyl)-imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anion, it is in principle possible to use all anions.

The anion [Y]ⁿ⁻ of the ionic liquid is, for example, selected from among
the group of halides and halogen-comprising compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae:

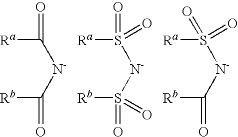

the group of methides of the general formula:

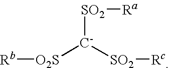

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by suitable functional groups, aryl, alkyl, aryloxy, alkyloxy, halogen, heteroatoms and/or heterocycles.

Here, C₁-C₁₈-alkyl which may optionally be substituted by suitable functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-dimethylaminoethyl, 2-dimethylaminopropyl, 3-dimethylaminopropyl, 4-dimethylaminobutyl, 6-dimethylaminohexyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may optionally be interrupted by one or more nonadjacent oxygen and/or sulfur atoms and/or one or more substituted or unsubstituted imino groups is, for example, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

The term “functional groups” refers, for example, to the following: carboxamide, di-(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may optionally be substituted by suitable functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may optionally be substituted by suitable functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preferred anions are selected from the group of halides and halogen-comprising compounds, the group of sulfates, sulfites and sulfonates, the group of phosphates and the group of carboxylic acids, in particular from the group of halides and halogen-comprising compounds, the group of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄⁻.

Preferred anions are, in particular, chloride, bromide, iodide, SCN⁻, OCN⁻, CN⁻, acetate, propionate, benzoate, C₁-C₄-alkylsulfates, R^{a}—COO⁻, R^{a}SO₃⁻, R^{a}R^{b}PO₄⁻, methanesulfonate, tosylate or di(C₁-C₄-alkyl)phosphates.

Particularly preferred anions are Cl⁻, CH₃COO⁻, C₂H₅COO⁻, C₃H₇COO⁻, C₆H₅COO⁻, CH₃SO₃⁻, (CH₃O)₂PO₂⁻ and (C₂H₅O)₂PO₂⁻.

Especially preferred anions are Cl⁻, CH₃SO₃⁻, (CH₃O)₂PO₂⁻ or (C₂H₅O)₂PO₂⁻.

Equally especially preferred are CH₃COO⁻, C₂H₅COO⁻, C₃H₇COO⁻ or C₆H₅COO⁻.

In a further preferred embodiment, ionic liquids of the formula I in which
[A]ₙ⁺ is 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium; and
[Y]ⁿ⁺ is Cl⁻, CH₃COO⁻, C₂H₅COO⁻, C₃H₇COO⁻, C₆H₅COO⁻, CH₃SO₃⁻, (CH₃O)₂PO₂⁻ or (C₂H₅O)₂PO₂⁻; especially Cl⁻, CH₃SO₃⁻, (CH₃O)₂PO₂⁻ or (C₂H₅O)₂PO₂⁻;
equally especially CH₃COO⁻, C₂H₅COO⁻, C₃H₇COO⁻ or C₆H₅COO⁻;
   are used.

In a further preferred embodiment, ionic liquids whose anions are selected from the group consisting of HSO₄⁻, HPO₄²⁻, H₂PO₄⁻ and HR^{a}PO₄⁻; in particular HSO₄⁻, are used

In particular, ionic liquids of the formula I in which
[A]ₙ⁺ is 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium or 1-(prop-1-en-3-yl)-3-methylimidazolium; and
[Y]ₙ⁺ is HSO₄⁻;
   are used.

In the process of the invention, use is made of one ionic liquid of the formula I or a mixture of ionic liquids of the formula I. Preference is given to using one ionic liquid of the formula I.

In a further embodiment of the invention, it is possible to use one ionic liquid of the formula II or a mixture of ionic liquids of the formula II. Preference is given to using one ionic liquid of the formula II.

In a further embodiment of the invention, it is possible to use a mixture of ionic liquids of the formulae I and II.

Silylating agents which can be used for the purposes of the present invention are ones which are able to transfer an SiR^{x}R^{y}R^{z} group to a hydroxy group to form an O—SiR^{x}R^{y}R^{z} group. Preference is given to using silylating agents of the formula IV

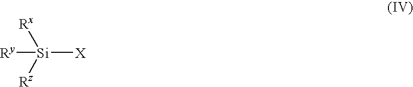

where the radicals have the following meanings:
R^{x}, R^{y}, R^{z} are each C₁-C₃₀-alkyl, C₂-C₃₀-alkenyl, C₂-C₃₀-alkynyl, C₃-C₁₂-cycloalkyl, C₅-C₁₂-cycloalkenyl or aryl, where the six radicals may optionally be substituted;
X is halogen, imidazol-1-yl, NH₂, di-(C₁-C₆-alkyl)amine, NH—SiR^{x}R^{y}R^{z}, NH—CO—NH—SiR^{x}R^{y}R^{z}, NHCO—(C₁-C₆-alkyl), N(C₁-C₆-alkyl)-CO—(C₁-C₆-alkyl), N(C₁-C₆-alkyl)-CO—(C₁-C₆-haloalkyl), O—SO₂—(C₁-C₆-alkyl), O—SO₂—(C₁-C₆-haloalkyl), O—C(═N—SiR^{x}R^{y}R^{z})—(C₁-C₆-alkyl) or O—C(═N—SiR^{x}R^{y}R^{z})—(C₁-C₆-haloalkyl).

Optionally substituted C₁-C₃₀-alkyl radicals R^{x}, R^{y} and R^{z} are, in particular, unsubstituted C₁-C₃₀-alkyl radicals or C₁-C₃₀-alkyl radicals substituted by suitable functional groups, aryl, alkyl, aryloxy, alkyloxy, cycloalkyl, halogen, heteroatoms and/or heterocycles,

preferably C₁-C₃₀-alkyl radicals, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl and 1-eicosanyl, particularly preferably methyl, ethyl, 1-propyl, 1-butyl, 1-decyl, 1-dodecyl, 1-tetradecyl or 1-hexadecyl;
or
preferably C₁-C₃₀-alkyl radicals substituted by suitable functional groups, aryl, alkyl, aryloxy, alkyloxy, cycloalkyl, halogen, heteroatoms and/or heterocycles, for example cyanomethyl, 2-cyanoethyl, 2-cyanopropyl, methoxycarbonylmethyl, 2-methoxycarbonylethyl, ethoxycarbonylmethyl, 2-ethoxycarbonylethyl, 2-(butoxycarbonyl)ethyl, 2-butoxycarbonylpropyl, 1,2-di-(methoxycarbonyl)ethyl, formyl, dimethylaminomethyl, phenoxymethyl, 2-phenoxyethyl, 2-phenoxypropyl, 3-phenoxypropyl, 4-phenoxybutyl, 6-phenoxyhexyl, methoxymethyl, 2-methoxyethyl, 2-methoxypropyl, 3-methoxypropyl, 4-methoxybutyl, 6-methoxyhexyl, ethoxymethyl, 2-ethoxyethyl, 2-ethoxypropyl, 3-ethoxypropyl, 4-ethoxybutyl, 6-ethoxyhexyl, 2-butoxyethyl, 2-isopropoxyethyl, 2-butoxypropyl, 2-octyloxyethyl, 2-methoxyisopropyl, dimethoxymethyl, diethoxymethyl, 2,2-diethoxymethyl, 2,2-diethoxyethyl, acetyl, propionyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methylthiomethyl, ethylthiomethyl, butylthiomethyl, 2-dodecylthioethyl, 2-phenylthioethyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

Optionally substituted C₂-C₃₀-alkenyl radicals R^{x}, R^{y} and R^{z} are, in particular, unsubstituted C₂-C₃₀-alkenyl radicals or C₂-C₃₀-alkenyl radicals substituted by suitable functional groups, aryl, alkyl, aryloxy, alkyloxy, cycloalkyl, halogen, heteroatoms and/or heterocycles,

preferably C₂-C₃₀-alkenyl radicals, for example vinyl, 2-propenyl, 3-butenyl, cis-2-butenyl or trans-2-butenyl, particularly preferably vinyl or 2-propenyl;
or
preferably C₂-C₃₀-alkenyl radicals substituted by suitable functional groups, aryl, alkyl, aryloxy, alkyloxy, cycloalkyl, halogen, heteroatoms and/or heterocycles, for example CₘF_{2(m-a)-(1-b)}H_{2a-b} where m≦30, 0≦a≦m and b=0 or 1.

Optionally substituted C₂-C₃₀-alkynyl radicals R^{x}, R^{y} and R^{z} are, in particular, unsubstituted C₂-C₃₀-alkynyl radicals or C₂-C₃₀-alkynyl radicals substituted by suitable functional groups, aryl, alkyl, aryloxy, alkyloxy, cycloalkyl, halogen, heteroatoms and/or heterocycles;

preferably C₂-C₃₀-alkynyl radicals such as ethynyl, 1-propyn-3-yl, 1-propyn-1-yl or 3-methyl-1-propyn-3-yl, particularly preferably ethynyl or 1-propyn-3-yl.

Optionally substituted C₃-C₁₂-cycloalkyl radicals R^{x}, R^{y} and R^{z} are, in particular, unsubstituted C₃-C₈-cycloalkyl radicals or C₃-C₁₂-cycloalkyl radicals substituted by suitable functional groups, aryl, alkyl, aryloxy, alkyloxy, cycloalkyl, halogen, heteroatoms and/or heterocycles,

preferably C₃-C₁₂-cycloalkyl radicals, for example cyclopropyl, cyclobutyl, cyclopentyl, cyclohexyl, cyclooctyl, cyclododecyl, methylcyclopentyl, dimethylcyclopentyl, methylcyclohexyl, dimethylcyclohexyl, diethylcyclohexyl or butylcyclohexyl, and also bicyclic systems such as norbornyl, preferably cyclopentyl or cyclohexyl;
or
preferably C₃-C₁₂-cycloalkyl radicals substituted by suitable functional groups, aryl, alkyl, aryloxy, alkyloxy, cycloalkyl, halogen, heteroatoms and/or heterocycles, for example methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1.

Optionally substituted C₅-C₁₂-cycloalkenyl radicals R^{x}, R^{y} and R^{z} are, in particular unsubstituted C₃-C₈-cycloalkenyl radicals or C₃-C₈-cycloalkenyl radicals substituted by suitable functional groups, aryl, alkyl, aryloxy, alkyloxy, cycloalkyl, halogen, heteroatoms and/or heterocycles,

preferably C₃-C₈-cycloalkenyl radicals, for example 3-cyclopentenyl, 2-cyclohexenyl, 3-cyclohexenyl, 2,5-cyclohexadienyl, and also bicyclic systems such as norbornyl, particularly preferably 3-cyclopentenyl, 2-cyclohexenyl or 3-cyclohexenyl;
or
preferably C₃-C₈-cycloalkenyl radicals substituted by suitable functional groups, aryl, alkyl, aryloxy, alkyloxy, cycloalkyl, halogen, heteroatoms and/or heterocycles, for example CₙF_{2(m-a)-3(1-b)}H_{2a-3b} where m≦12, 0≦a≦m and b=0 or 1.

Optionally substituted aryl radicals R^{x}, R^{y} and R^{z} are, in particular, unsubstituted C₆-C₁₂-aryl radicals or C₆-C₁₂-aryl radicals substituted by suitable functional groups, aryl, alkyl, aryloxy, alkyloxy, cycloalkyl, halogen, heteroatoms and/or heterocycles, preferably C₆-C₁₂-aryl radicals, for example phenyl, α-naphthyl or β-naphthyl, particularly preferably phenyl;

or
preferably C₆-C₁₂-aryl radicals substituted by suitable functional groups, aryl, alkyl, aryloxy, alkyloxy, cycloalkyl, halogen, heteroatoms and/or heterocycles, e.g. tolyl, xylyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5, particularly preferably 4-tolyl.

C₁-C₆-alkyl radicals as a subset of meanings of substituents X are, for example, methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl or 3,3-dimethyl-2-butyl, preferably methyl, ethyl, 1-propyl, 1-butyl, 1-pentyl or 1-hexyl, in particular methyl or ethyl.

C₁-C₆-haloalkyl radicals as a subset of meanings of substituents X are, for example, C₁-C₆-alkyl radicals as described above which have been partially or fully substituted by fluorine, chlorine, bromine and/or iodine, e.g. chloromethyl, dichloromethyl, trichloromethyl, fluoromethyl, difluoromethyl, trifluoromethyl, chlorofluoromethyl, dichlorofluoromethyl, chlorodifluoromethyl, bromomethyl, iodomethyl, 2-fluoroethyl, 2-chloroethyl, 2-bromoethyl, 2-Iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl, nonafluorobutyl, 1,1,2,2-tetrafluoroethyl, 1-trifluoromethyl-1,2,2,2,2-tetrafluoroethyl, 5-fluoropentyl, 5-chloropentyl, 5-bromopentyl, 5-iodopentyl, undecafluoropentyl, 6-fluorohexyl, 6-chlorohexyl, 6-bromohexyl, 6-iodohexyl or tridecafluorohexyl, preferably chloromethyl or trifluoromethyl.

The silylating agents R^{x}R^{y}R^{z}Si—NH—SiR^{x}R^{y}R^{z}, R^{x}R^{y}R^{z}Si—O—C(═N—SiR^{x}R^{y}R^{z})—(C₁-C₆-alkyl) and R^{x}R^{y}R^{z}Si—O—C(═N—SiR^{x}R^{y}R^{z})—(C₁-C₆-haloalkyl) can transfer not only one of the R^{x}R^{y}R^{z}Si— groups comprised in the respective molecule but all.

In an embodiment of the present invention, use is made of silylating agents of the formula IV in which the radicals have the following meanings:
R^{x}, R^{y}, R^{z} are each C₁-C₃₀-alkyl, C₂-C₃₀-alkenyl, C₂-C₃₀-alkynyl, C₃-C₁₂-cycloalkyl, C₅-C₁₂-cycloalkenyl or aryl, where these six radicals may optionally be substituted; in particular C₁-C₃₀-alkyl or aryl, where these radicals may optionally be substituted, preferably C₁-C₆-alkyl or phenyl; in particular C₁-C₄-alkyl or phenyl, preferably C₁-C₄-alkyl;
X is halogen, imidazol-1-yl, di-(C₁-C₆)amine, NH—SiR^{x}R^{y}R^{z}, NH—CO—NH—SiR^{x}R^{y}R^{z}, NHCO—(C₁-C₆-alkyl), N(C₁-C₆-alkyl)-CO—(C₁-C₆-alkyl), N(C₁-C₆-alkyl)-CO—(C₁-C₆-haloalkyl), O—SO₂—(C₁-C₆-alkyl), O—SO₂—(C₁-C₆-haloalkyl), O—C(═N—SiR^{x}R^{y}R^{z})—(C₁-C₆-alkyl) or O—C(═N—SiR^{x}R^{y}R^{z})—(C₁-C₆-haloalkyl); in particular halogen, imidazol-1-yl, di-(C₁-C₆-alkyl)amine, NH—SiR^{x}R^{y}R^{z}, O—C(═N—SiR^{x}R^{y}R^{z})—(C₁-C₆-alkyl) or O—C(═N—SiR^{x}R^{y}R^{z})—(C₁-C₆-haloalkyl) preferably chlorine, di-(C₁-C₄-alkyl)amine, NH—SiR^{x}R^{y}R^{z}, O—C(═N—SiR^{x}R^{y}R^{z})—(C₁-C₄-alkyl) or O—C(═N—SiR^{x}R^{y}R^{z})—(C₁-C₄-haloalkyl); preferably chlorine, diethylamine, NH—SiR^{x}R^{y}R^{z}, O—C(═N—SiR^{x}R^{y}R^{z})—CH₃ or O—C(═N—SiR^{x}R^{y}R^{z})—CF₃.

In a particular embodiment of the present invention, hexamethyldisilazane (HMDS), trimethylsilyldiethylamine or N,O-bis(trimethylsilyl)acetamide is used as silylating agent of the formula IV.

In the silylation according to the invention of cellulose, it is possible to use celluloses from a wide variety of sources, e.g. from cotton, flax, ramie, straw, bacteria, etc. or from wood or bagasse, in the cellulose-enriched form.

However, the process of the invention can be used not only for the silylation of cellulose but also generally for the silylation of polysaccharides, oligosaccharides and disaccharides and also derivatives thereof. Examples of polysaccharides include cellulose and hemicellulose and also starch, glycogen, dextran and tunicin. Further examples are the polycondensates of D-fructose, e.g. inulin, and also, inter alia, chitin, chitosan and alginic acid. Sucrose is an example of a disaccharide. Suitable cellulose derivatives are those whose DS is <3, including cellulose ethers such as methyl cellulose and carboxymethylcellulose, cellulose esters such as cellulose acetate, cellulose butyrate and cellulose nitrate, in each case with a DS of <3. The corresponding statements apply analogously here.

In one embodiment of the present invention, a polysaccharide such as cellulose, hemicellulose, starch, glycogen, dextran, tunicin, inulin, chitin, chitosan or alginic acid, preferably cellulose, is silylated by the process of the invention.

In a further embodiment of the present invention, a disaccharide such as sucrose is silylated by the process of the invention.

In a further embodiment of the present invention, a cellulose derivative whose DS is <3, e.g. a cellulose ether such as methylcellulose or carboxymethylcellulose, a cellulose ester such as cellulose acetate, cellulose butyrate or cellulose nitrate, in each case having a DS of <3, is silylated by the process of the invention.

The statements below apply not only to cellulose but also analogously to the other polysaccharides, oligosaccharides and disaccharides and derivatives thereof.

In the process of the invention, a solution of cellulose in an ionic liquid is prepared. The concentration of cellulose here can be varied within a wide range. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution procedure can be carried out at room temperature or with heating, but above the melting point or softening temperature of the ionic liquid, usually at a temperature of from 0 to 200° C., preferably from 20 to 180° C., particularly preferably from 50 to 150° C. However, it is also possible to accelerate dissolution by intensive stirring or mixing or by introduction of microwave or ultrasonic energy or by a combination of these.

The silylating agent of the formula IV is then added to the resulting solution.

The silylating agent of the formula IV can be added as such or as a solution in an ionic liquid or a suitable solvent. Suitable solvents are, for example, ethers such as diethyl ether, methyl tert-butyl ether, tetrahydrofuran or dioxane, or ketones such as dimethyl ketone, halogenated hydrocarbons such as dichloromethane, trichloromethane or dichloroethane, or hydrocarbons, for example aromatic hydrocarbons such as benzene, toluene, xylene or mesitylene. The amount of solvent used to dissolve the silylating agent of the formula IV should be such that no precipitation of the cellulose occurs when the addition is carried out. Ionic liquids used are preferably those in which cellulose itself, as described above, is dissolved.

In a particular embodiment, the silylating agent of the formula IV is added as such.

In a further particular embodiment, the silylating agent of the formula IV is added as a solution in an ionic liquid, with particular preference being given to using the ionic liquid which is also used for dissolving the cellulose.

In another embodiment, the ionic liquid and the silylating agent of the formula IV are premixed and the cellulose is dissolved in this mixture.

It is also possible for one or more further solvents to be added to the reaction mixture or be introduced together with the ionic liquid or the silylating agent of the formula IV. Possible solvents here are solvents which do not adversely affect the solubility of the cellulose, for example aprotic dipolar solvents such as dimethyl sulfoxide, dimethylformamide, dimethylacetamide or sulfolane. Furthermore, nitrogen-comprising bases such as pyridine, etc., can be additionally added.

In a particular embodiment, the reaction mixture comprises, apart from the ionic liquid and any solvent in which the silylating agent of the formula IV has been dissolved, less than 5% by weight, preferably less than 2% by weight, in particular less than 0.1% by weight, based on the total weight of the reaction mixture, of further solvents and/or additional nitrogen-comprising bases.

It is also possible to carry out the process of the invention in the presence of a catalyst. Suitable catalysts here are, for example, monosaccharides or disaccharides, e.g. glucose or sucrose, or saccharin, preferably saccharin. The catalyst is usually used in amounts of up to 10 mol %, preferably up to 5 mol %, based on the silylating agent of the formula IV.

It can sometimes also be advantageous to carry out the silylating in the presence of a tertiary amine such as triethylamine, an aromatic nitrogen base, e.g. pyridine, or mixtures thereof, particularly when an acid is liberated in the silylation. This can occur particularly when using silylating agents of the formula IV in which X=halogen, O—SO₂—(C₁-C₆-alkyl), O—SO₂—(C₁-C₆-haloalkyl), O—C(═N—SiR^{x}R^{y}R^{z})—(C₁-C₆-alkyl) or O—C(═N—SiR^{x}R^{y}R^{z})—(C₁-C₆-haloalkyl). The tertiary amine, the aromatic nitrogen base or the mixtures thereof are usually used in the stoichiometric ratio. It can sometimes also be advantageous to use an excess or a substoichiometric amount.

The reaction is, depending on the ionic liquid used and the reactivity of the silylating agent of the formula IV used, usually carried out at a temperature from the melting point of the ionic liquid up to 200° C., preferably from 20 to 180° C., in particular from 50 to 150° C.

The reaction is usually carried out at ambient pressure. However, it can sometimes also be advantageous to carry it out under superatmospheric pressure, particularly when a volatile silylating agent of the formula IV is used. In general, the reaction is carried out in air or under a protective gas atmosphere, i.e., for example, under N₂, a noble gas or a mixture thereof.

The amount of silylating agent used, in each case relative to the amount of cellulose used, the reaction time and, if appropriate, the reaction temperature are set as a function of the desired degree of substitution of the cellulose.

For example, if the cellulose which is made up of an average of u anhydroglucose units is to be completely silylated, then 3u equivalents of silylating agent of the formula IV are required when the silylating agent transfers one silyl group. Preference is here given to using the stoichiometric amount of silylating agent of the formula IV (n_{silylating agent}/n_{anhydroglucose units}=3) or an excess, preferably an excess of from 10 to 500 mol %, in particular from 10 to 300 mol %, particularly preferably from 10 to 200 mol %, based on u. When the silylating agent can transfer a plurality of silyl groups, the amounts of silylating agent of the formula IV which are used are reduced correspondingly.

If the cellulose which is made up of an average of u anhydroglucose units is to be partially silylated, then the amounts of silylating agent of the formula IV used are usually adapted accordingly (n_{silylating agent}/n_{anhydroglucose units}<3, when the silylating agent of the formula IV transfers one silyl group). The smaller the ratio n_{silylating agent}/n_{anhydroglucose units}, the smaller the average degree of substitution of the silylated cellulose under otherwise identical conditions and identical reaction time. When the silylating agent can transfer a plurality of silyl groups, the amounts of silylating agent of the formula IV used or the reaction time is reduced correspondingly.

Furthermore, it is possible to stop the silylation reaction when the desired degree of silylation has been reached by separating off the silylated cellulose from the reaction mixture. This can be effected, for example, by addition of an excess of a suitable solvent in which the silylated cellulose is not soluble but the ionic liquid is readily soluble, e.g. a lower alcohol such as methanol, ethanol, propanol or butanol, or a ketone, for example diethyl ketone, etc., or mixtures thereof. The choice of suitable solvent is also determined by the respective degree of substitution and the substituents on the cellulose. Preference is given to using an excess of methanol.

The reaction mixture is usually worked up by precipitating the silylated cellulose as described above and filtering off the silylated cellulose. However, it is also possible to carry out the separation by centrifugation. The ionic liquid can be recovered from the filtrate or the centrifugate by conventional methods, by distilling off the volatile components, e.g. the precipitant or excess silylating agent of the formula IV (or reaction products and/or hydrolysis products of the silylating agent of the formula IV), etc. The ionic liquid which remains can be reused in the process of the invention.

However, it is also possible to introduce the reaction mixture into methanol or into another suitable solvent in which the silylated cellulose is not soluble but the ionic liquid is readily soluble, e.g. another lower alcohol such as ethanol, propanol or butanol or a ketone, for example diethyl ketone, etc., or mixtures thereof and, depending on the embodiment, obtain, for example, fibers, films of silylated cellulose. The choice of suitable solvent is also determined by the respective degree of substitution and the substituents on the cellulose. The filtrate is worked up as described above.

Furthermore, it is possible to stop the silylation reaction when the desired degree of silylation has been reached by cooling the reaction mixture and working it up. The work-up can be carried out by the methods indicated above.

The silylation reaction can also be stopped by removing silylating agent of the formula IV still present from the reaction mixture by distillation, stripping or extraction with a solvent which forms two phases with the ionic liquid at a given point in time.

If the silylated cellulose precipitates from the ionic liquid or the reaction mixture during the reaction, it can be advantageous to separate off the silylated cellulose by filtration after the reaction is complete and, if appropriate, wash it with a suitable solvent. As an alternative, a suitable solvent which is not miscible with the reaction mixture but dissolves the silylated cellulose can be added when the reaction is complete. After phase separation, the silylated cellulose is recovered from the extract by distilling off the solvent added. Possible solvents for this are, for example, hydrocarbons such as aromatic hydrocarbons, e.g. benzene, toluene, xylene, mesitylene or mixtures thereof. It can sometimes also be advantageous to add this solvent right at the beginning of the reaction, in which case the reaction then takes place in a two-phase (liquid/liquid) system.

In a further embodiment of the present invention, the cellulose is reacted with a silylating agent of the formula IV in an ionic liquid of the formula I, in which case [Y]ⁿ⁻ is R^{a}COO—. In this case, in addition to the silylation of the cellulose, it is also sometimes possible for an acylation of the cellulose to occur, in which case the radical R^{a}COO is transferred.

In a further embodiment of the present invention, the cellulose can be reacted with two or more silylating agents of the formula IV which transfer different silyl groups. In this case, it is possible to use a mixture of two (or more) silylating agents of the formula IV in a manner analogous to the above procedure. However, it is also possible firstly to carry out the reaction to a DS=a (<3) using the first silylating agent of the formula IV and then carry out the reaction to a DS=b, where a<b≦3, using a second silylating agent of the formula IV.

In this embodiment, silylated celluloses which bear two (or more) different silyl radicals (as a function of the silylating agent of the formula IV used) are obtained.

If the ionic liquid is circulated, the ionic liquid can comprise up to 15% by weight, preferably up to 10% by weight, in particular up to 5% by weight, of precipitant(s) as described above, as long as these do not lead to decomposition of the silylating agent used.

The process can be carried out batchwise, semicontinuously or continuously.

It can also be advantageous to carry out the reaction with exclusion of moisture, since silylating agents are generally moisture-sensitive. For this purpose, the reagents, solvents, etc., used are dried by customary laboratory methods, the ionic liquid used and the cellulose can, for example, be dried by heating under reduced pressure, and any solvents and protective gases used can be dried by methods known to those skilled in the art, etc. However, it is also possible to dispense with these precautions, but correspondingly larger amounts of silylating agent are then consumed.

In a further embodiment, the cellulose used can be dissolved in an ionic liquid of the formula I or II or a mixture thereof and the cellulose can be degraded to a desired average degree of polymerization DP in the presence of an acid, if appropriate with addition of water, in step a1) and the degraded cellulose obtained in this way can be subjected to a silylation as described above in a step b).

Step a1) can be carried out as follows:

As acid, it is possible to use inorganic acids, organic acids or mixtures thereof.

Examples of inorganic acids are hydrohalic acids such as HF, HCl, HBr or HI, perhalic acids such as HClO₄, halic acids such as HClO₃, sulfur-comprising acids such as H₂SO₄, polysulfuric acid or H₂SO₃, nitrogen-comprising acids such as HNO₃, or phosphorus-comprising acids such as H₃PO₄, polyphosphoric acid or H₃PO₃. Preference is given to using hydrohalic acids such as HCl or HBr, H₂SO₄, HNO₃ or, H₃PO₄ in particular HCl, H₂SO₄ or H₃PO₄.

Examples of organic acids are carboxylic acids such as
C₁-C₆-alkanecarboxylic acids, for example acetic acid, propionic acid, n-butanecarboxylic acid or pivalic acid,
dicarboxylic or polycarboxylic acids, for example succinic acid, maleic acid or fumaric acid,
hydrocarboxylic acids, for example hydroxyacetic acid, lactic acid, maleic acid or citric acid,
halogenated carboxylic acids, for example C₁-C₆-haloalkanecarboxylic acids, e.g. fluoroacetic acid, chloroacetic acid, bromoacetic acid, difluoroacetic acid, dichloroacetic acid, chlorofluoroacetic acid, trifluoroacetic acid, trichloroacetic acid, 2-chloropropionic acid, perfluoropropionic acid or perfluorobutanecarboxylic acid,
aromatic carboxylic acids, for example arylcarboxylic acids such as benzoic acid;
   or sulfonic acids such as
C₁-C₆-alkanesulfonic acids, for example methanesulfonic acid or ethanesulfonic acid,
halogenated sulfonic acids, for example C₁-C₆-haloalkanesulfonic acids such as trifluoromethanesulfonic acid,
aromatic sulfonic acids, for example arylsulfonic acids such as benzenesulfonic acid or 4-methylphenylsulfonic acid.

As organic acids, preference is given to using C₁-C₆-alkanecarboxylic acids, for example acetic acid or propionic acid, halogenated carboxylic acids for example C₁-C₆-haloalkanecarboxylic acids, e.g. fluoroacetic acid, chloroacetic acid, difluoroacetic acid, dichloroacetic acid, chlorofluoroacetic acid, trifluoroacetic acid, trichloroacetic acid or perfluoropropionic acid, or sulfonic acids such as C₁-C₆-alkanesulfonic acids, for example methanesulfonic acid or ethanesulfonic acid, halogenated sulfonic acids, for example C₁-C₆-haloalkanesulfonic acids such as trifluoromethanesulfonic acid, or arylsulfonic acids such as benzenesulfonic acid or 4-methylphenylsulfonic acid. Preference is given to using acetic acid, chlorofluoroacetic acid, trifluoroacetic acid, perfluoropropionic acid, methanesulfonic acid, trifluoromethanesulfonic acid or 4-methylphenylsulfonic acid.

In a particular embodiment of the invention, sulfuric acid, acetic acid, trifluoroacetic acid, methanesulfonic acid or 4-methylphenylsulfonic acid is used as acid. If 4-methylphenylsulfonic acid monohydrate is used, one equivalent of water is present at the same time.

In a particular embodiment, ionic liquids and acids whose anions are identical are used. These anions are preferably acetic, trifluoroacetate, chloride or bromide.

In a further particular embodiment, ionic liquids and acids whose anions are not identical are used.

The acid and if appropriate water are added to the solution of the cellulose in the ionic liquid. The addition of water can be necessary when the water adhering to the cellulose used is not sufficient to achieve the desired degree of degradation. In general, the water content of normal cellulose is in the range from 5 to 10% by weight, based on the total weight of the cellulose used (cellulose per se+adhering water). To achieve partial degradation of the cellulose, substoichiometric amounts of water and acid are added or the reaction is stopped at a given point in time.

In another embodiment, the ionic liquid, acid and, if appropriate, water are premixed and the cellulose is dissolved in this mixture.

It is also possible for one or more further solvents to be added to the reaction mixture or to be added together with the ionic liquid and/or the acid and/or, if appropriate, the water. Possible solvents here are ones which do not adversely affect the solubility of the cellulose, e.g. aprotic dipolar solvents, for example dimethyl sulfoxide, dimethylformamide, dimethylacetamide or sulfolane.

In a particular embodiment, the reaction mixture comprises less than 5% by weight, preferably less than 2% by weight, in particular less than 0.1% by weight, of further solvents, based on the total weight of the reaction mixture.

Depending on the ionic liquid used and the acid used, the hydrolysis is usually carried out at a temperature from the melting point of the ionic liquid to 200° C., preferably from 20 to 180° C., in particular from 50 to 150° C.

The reaction is usually carried out at ambient pressure. However, it can sometimes also be advantageous to carry it out under superatmospheric pressure, particularly when volatile acids are used.

In general, the reaction is carried out in air. However, it is also possible to carry it out under inert gas, i.e., for example, under N₂, a noble gas or a mixture thereof.

The amount of acid used, the water added if appropriate, in each case relative to the cellulose used, the reaction time and if appropriate the reaction temperature are set as a function of the desired degree of degradation.

If the cellulose which is made up of an average of x anhydroglucose units is to be converted into a cellulose whose number of anhydroglucose units is less than x, the amounts of water used and acid used are usually matched to the degree of degradation ((n_{anhydroglucose units}/n_{acid}>1). The larger the ratio n_{anhydroglucose units}/n_{acid}, the smaller the average degradation of cellulose under otherwise identical reaction conditions and identical reaction time. The larger the ratio n_{anhydroglucose units}/n_{water}, the smaller the average degradation of cellulose under otherwise identical reaction conditions and identical reaction time.

It is also possible to stop the hydrolysis reaction when the desired degree of degradation has been reached by scavenging the acid by means of a base. Suitable bases include both inorganic bases such as alkali metal hydroxides, carbonates, hydrogencarbonates and organic bases such as amines and are used in a stoichiometric ratio to the acid or in excess. In a further embodiment, a hydroxide whose cation corresponds to that of the ionic liquid used can be used as base.

Furthermore, it is possible to stop the degradation reaction when the desired degree of degradation has been reached by adding appropriate amounts of silylating agent of the formula IV, which react with water still present.

The solution obtained in this way is then used in step b) as described above.

In a further embodiment, it is possible to dissolve the cellulose used in an ionic liquid of the formula I or II or mixtures thereof and treat the cellulose, if appropriate with addition of water, at elevated temperature in step a2) and subject the degraded cellulose obtained in this way to silylation in step b), as described above.

Step a2) can be carried out as follows:

If ionic liquids which have no acid functions are used, the degradation is usually carried out at temperatures of from 50 to 200° C., preferably from 80° C. to 180, in particular from 80 to 150° C. Possible ionic liquids here are ones whose anions are selected from the group of halides and halogen-comprising compounds, the group of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄⁻. Preferred anions here are chloride, bromide, iodide, SCN⁻, OCN⁻, CN⁻, acetate, C₁-C₄ alkylsulfates, R^{a}—COO⁻, R^{a}SO₃⁻, R^{a}R^{b}PO₄⁻, methanesulfonate, tosylate or C₁-C₄-dialkylphosphates; particularly preferred anions are Cl⁻, CH₃COO⁻, C₂H₅COO⁻, C₆H₅COO⁻, CH₃SO₃⁻, (CH₃O)₂PO₂⁻ or (C₂H₅O)₂PO₂⁻.

If ionic liquids which have acid functions are used, then it is possible to carry out the degradation of the cellulose at a temperature from 0 to 150° C., preferably from 20 to 150° C., in particular from 50 to 150° C. Possible ionic liquids here are, in particular, ones whose anions are selected from the group consisting of HSO₄⁻, HPO₄²⁻, H₂PO₄⁻ and HR^{a}PO₄⁻; in particular HSO₄⁻.

In one embodiment, the preparation of the reaction solution and the degradation are carried out at the same temperature.

In a further embodiment, the preparation of the reaction solution and the degradation are carried out at different temperatures.

It is sometimes also possible for degradation of the cellulose to take place during the preparation of the reaction solution. In a specific embodiment, the dissolution process and the degradation process take place essentially in parallel.

The reaction is usually carried out at ambient pressure. However, it can sometimes also be advantageous to carry it out at superatmospheric pressure.

In general, the reaction is carried out in air. However, it is also possible to carry it out under inert gas, i.e., for example, under N₂, a noble gas or mixtures thereof.

The reaction time and the reaction temperature are set as a function of the desired degree of degradation.

In one embodiment, water is added. In the case of partial degradation of the cellulose, substoichiometric amounts of water are preferably added or the reaction is stopped.

If the degradation is carried out in the presence of water, it is possible to premix the ionic liquid and the water and to dissolve the cellulose in this mixture. However, it is also possible to add water to the solution of ionic liquid and cellulose.

If the cellulose which is made up of an average of x anhydroglucose units is to be converted into a cellulose whose number of anhydroglucose units is less than x, the amounts of water used are usually matched to the degree of degradation (n_{anhydroglucose units}/n_{water}>1). The larger the ratio n_{anhydroglucose units}/n_{water}, the lower the average degree of degradation of cellulose under otherwise identical reaction conditions and identical reaction time and the higher the DP of the degraded cellulose (which naturally will be lower than the DP of the cellulose used).

In another embodiment, water is not added. This is generally the case when the ionic liquid used contains small amounts of water and/or when water adheres to the cellulose that is used. The water fraction in typical cellulose can be up to 10% by weight, based on the total weight of the cellulose used. The observations above apply correspondingly.

It is also possible to add one or more further solvents to the reaction mixture or to the water if the latter has been added. Possible solvents here are ones which do not adversely affect the solubility of the cellulose, e.g. aprotic dipolar solvents, for example dimethyl sulfoxide, dimethylformamide, dimethylacetamide or sulfolane.

In a particular embodiment, the reaction mixture comprises less than 5% by weight, preferably less than 2% by weight, in particular less than 0.1% by weight, of further solvents, based on the total weight of the reaction mixture.

Furthermore, it is possible to stop the degradation reaction when the desired degree of degradation has been reached by adding appropriate amounts of silylating agent of the formula IV, which react with water still present.

The solution obtained in this way is then used in step b) as described above.

In a further embodiment, a silylated cellulose with a DS<3 can be acylated. For the purposes of the present invention, acylating agents are carboxylic acid derivatives and also ketenes and diketenes.

For the purposes of the present invention, carboxylic acid derivatives are carboxylic acid derivatives of the formula V

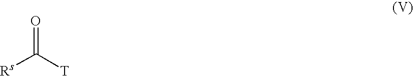

where the radicals have the following meanings:
R^{s}, R^{s′} are each H, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven last-named radicals may optionally be substituted;
T is halogen, imidazol-1-yl or O—COR^{s′}.

For the purposes of the present invention, ketenes (compounds of the formula VI) are ketenes of the formula VIa and, for the purposes of the present invention, diketenes are diketenes of the formula VIb1 or mixed diketenes of the formula VIb2,

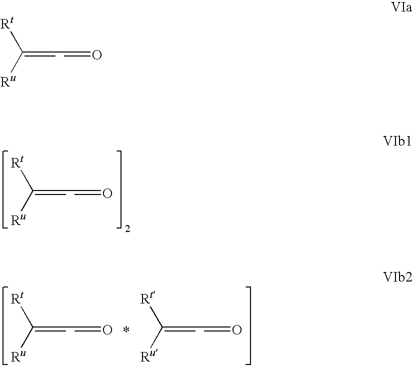

where the radicals have the following meanings:
R^{t}, R^{t′}, R^{u}, R^{u′} are each hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the seven last-named radicals may optionally be substituted;
   or
R^{t} and R^{u} or R^{t′} and R^{u′} together form an optionally substituted —Yₒ—(CH₂)ₚ—, —(CH₂)_{q}—Y—(CH₂)ᵣ— or a —CH═CH—CH═CH— chain, where
   Y is O, S, S(═O), S(═O)₂, NH or NC₁-C₆-alkyl;
   o is 0 or 1;
   p is 2, 3, 4, 5, 6, 7 or 8;
   q, r are each 1, 2, 3, 4, 5 or 6.

Optionally substituted C₁-C₃₀-alkyl radicals R^{s}, R^{s′}, R^{t}, R^{t′}, R^{u} and R^{u′} are, in particular, unsubstituted C₁-C₃₀-alkyl radicals or C₁-C₃₀-alkyl radicals substituted by functional groups, aryl, alkyl, aryloxy, alkyloxy, cycloalkyl, halogen, heteroatoms and/or heterocycles,

preferably C₁-C₃₀-alkyl radicals, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl and 1-eicosanyl, particularly preferably methyl, ethyl, 1-propyl, 1-butyl, 1-decyl, 1-dodecyl, 1-tetradecyl or 1-hexadecyl;
or
preferably C₁-C₃₀-alkyl radicals substituted by functional groups, aryl, alkyl, aryloxy, alkyloxy, cycloalkyl, halogen, heteroatoms and/or heterocycles, for example cyanomethyl, 2-cyanoethyl, 2-cyanopropyl, methoxycarbonylmethyl, 2-methoxycarbonylethyl, ethoxycarbonylmethyl, 2-ethoxycarbonylethyl, 2-(butoxycarbonyl)ethyl, 2-butoxycarbonylpropyl, 1,2-di(methoxycarbonyl)ethyl, formyl, hydroxymethyl, 2-hydroxyethyl, 2-hydroxypropyl, 3-hydroxypropyl, 4-hydroxybutyl, 6-hydroxyhexyl, 2-hydroxy-2,2-dimethylethyl, aminomethyl, 2-aminoethyl, 2-aminopropyl, 3-aminopropyl, 4-aminobutyl, 6-aminohexyl, methylaminomethyl, 2-methylaminoethyl, 2-methylaminopropyl, 3-methylaminopropyl, 4-methylaminobutyl, 6-methylamino-hexyl, dimethylaminomethyl, 2-dimethylaminoethyl, 2-dimethylaminopropyl, 3-dimethylaminopropyl, 4-dimethylaminobutyl, 6-dimethylaminohexyl, phenoxymethyl, 2-phenoxyethyl, 2-phenoxypropyl, 3-phenoxypropyl, 4-phenoxybutyl, 6-phenoxyhexyl, methoxymethyl, 2-methoxyethyl, 2-methoxypropyl, 3-methoxypropyl, 4-methoxybutyl, 6-methoxyhexyl, ethoxymethyl, 2-ethoxyethyl, 2-ethoxypropyl, 3-ethoxypropyl, 4-ethoxybutyl, 6-ethoxyhexyl, 2-butoxyethyl, 2-isopropoxyethyl, 2-butoxypropyl, 2-octyloxyethyl, 2-methoxyisopropyl, dimethoxymethyl, diethoxymethyl, 2,2-diethoxymethyl, 2,2-diethoxyethyl, acetyl, propionyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methylthiomethyl, ethylthiomethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

Optionally substituted C₂-C₃₀-alkenyl radicals R^{s}, R^{s′}, R^{t}, R^{t′}, R^{u} and R^{u′} are, in particular, unsubstituted C₂-C₃₀-alkenyl radicals or C₂-C₃₀-alkenyl radicals substituted by functional groups, aryl, alkyl, aryloxy, alkyloxy, cycloalkyl, halogen, heteroatoms and/or heterocycles,

preferably C₂-C₃₀-alkenyl radicals, for example vinyl, 2-propenyl, 3-butenyl, cis-2-butenyl or trans-2-butenyl, particularly preferably vinyl or 2-propenyl;
or
preferably C₂-C₃₀-alkenyl radicals substituted by functional groups, aryl, alkyl, aryloxy, alkyloxy, cycloalkyl, halogen, heteroatoms and/or heterocycles, for example CₘF_{2(m-a)-(1-b)}H_{2a-b} where m≦30, 0≦a≦m and b=0 or 1.

Optionally substituted C₂-C₃₀-alkynyl radicals R^{s}, R^{s′}, R^{t}, R^{t′}, R^{u} and R^{u′} are, in particular, unsubstituted C₂-C₃₀-alkynyl radicals or C₂-C₃₀-alkynyl radicals substituted by functional groups, aryl, alkyl, aryloxy, alkyloxy, cycloalkyl, halogen, heteroatoms and/or heterocycles,

preferably C₂-C₃₀-alkynyl radicals, for example ethynyl, 1-propyn-3-yl, 1-propyn-1-yl or 3-methyl-1-propyn-3-yl, particularly preferably ethynyl or 1-propyn-3-yl. Optionally substituted C₃-C₁₂-cycloalkyl radicals R^{s}, R^{s′}, R^{t}, R^{t′}, R^{u} and R^{u′} are, in particular, unsubstituted C₃-C₈-cycloalkyl radicals or C₃-C₁₂-cycloalkyl radicals substituted by functional groups, aryl, alkyl, aryloxy, alkyloxy, cycloalkyl, halogen, heteroatoms and/or heterocycles,
preferably C₃-C₁₂-cycloalkyl radicals, for example cyclopropyl, cyclobutyl, cyclopentyl, cyclohexyl, cyclooctyl, cyclododecyl, methylcyclopentyl, dimethylcyclopentyl, methylcyclohexyl, dimethylcyclohexyl, diethylcyclohexyl or butylcyclohexyl, and also bicyclic systems such as norbornyl, preferably cyclopentyl or cyclohexyl;
or
preferably C₃-C₁₂-cycloalkyl radicals substituted by functional groups, aryl, alkyl, aryloxy, alkyloxy, cycloalkyl, halogen, heteroatoms and/or heterocycles, for example methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1.

Optionally substituted C₅-C₁₂-cycloalkenyl radicals R^{s}, R^{s′}, R^{t}, R^{t′}, R^{u} and R^{u′} are, in particular unsubstituted C₃-C₈-cycloalkenyl radicals or C₃-C₈-cycloalkenyl radicals substituted by functional groups, aryl, alkyl, aryloxy, alkyloxy, cycloalkyl, halogen, heteroatoms and/or heterocycles,

preferably C₃-C₈-cycloalkenyl radicals, for example 3-cyclopentenyl, 2-cyclohexenyl, 3-cyclohexenyl, 2,5-cyclohexadienyl, and also bicyclic systems such as norbornyl, particularly preferably 3-cyclopentenyl, 2-cyclohexenyl or 3-cyclohexenyl;
or
preferably C₃-C₈-cycloalkenyl radicals substituted by functional groups, aryl, alkyl, aryloxy, alkyloxy, cycloalkyl, halogen, heteroatoms and/or heterocycles, for example CₙF_{2(m-a)-3(1-b)}H_{2a-3b} where m≦12, 0≦a≦m and b=0 or 1.

Optionally substituted aryl radicals R^{s}, R^{s′}, R^{t}, R^{t′}, R^{u} and R^{u′} are, in particular, unsubstituted C₆-C₁₂-aryl radicals or C₆-C₁₂-aryl radicals substituted by functional groups, aryl, alkyl, aryloxy, alkyloxy, cycloalkyl, halogen, heteroatoms and/or heterocycles,

preferably C₆-C₁₂-aryl radicals, for example phenyl, α-naphthyl or β-naphthyl, particularly preferably phenyl;
or
preferably C₆-C₁₂-aryl radicals substituted by functional groups, aryl, alkyl, aryloxy, alkyloxy, cycloalkyl, halogen, heteroatoms and/or heterocycles, e.g. tolyl, xylyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5, particularly preferably 4-tolyl.

Optionally substituted heterocyclyl radicals are, in particular, unsubstituted heteroaryl radicals or heteroaryl radicals substituted by functional groups, aryl, alkyl, aryloxy, alkyloxy, cycloalkyl, halogen, heteroatoms and/or heterocycles,

preferably 5- or 6-membered heteroaryl radicals comprising oxygen, nitrogen and/or sulfur atoms, e.g. furyl, thiophenyl, pyrryl, pyridyl, indolyl, benzoxazolyl, dioxolyl, dioxyl, benzimidazolyl or benzthiazolyl;
or
preferably 5- or 6-membered heteroaryl radicals which comprise oxygen, nitrogen and/or sulfur atoms and are substituted by functional groups, aryl, alkyl, aryloxy, alkyloxy, cycloalkyl, halogen, heteroatoms and/or heterocycles, e.g. methylpyridyl, dimethylpyridyl, methylquinolyl, dimethylpyrryl, methoxyfuryl, dimethoxypyridyl, chloropyridyl or difluoropyridyl.

If R^{t} and R^{u} or R^{t′} and R^{u′} together form an optionally substituted —Yₒ—(CH₂)ₚ—, —(CH₂)_{q}—Y—(CH₂)ᵣ— or a —CH═CH—CH═CH— chain, preference is given to a —Yₒ—(CH₂)ₚ—, —(CH₂)_{q}—Y—(CH₂)ᵣ— or a —CH═CH—CH═CH— chain, particularly preferably —(CH₂)₅—, —(CH₂)₆— or —CH═CH—CH═CH—, in particular —(CH₂)₅— or —(CH₂)₆—,

or
a C₁-C₄-alkyl-substituted —Yₒ—(CH₂)ₚ—, —(CH₂)_{q}—Y—(CH₂)ᵣ— or —CH═CH—CH═CH— chain.

In an embodiment of the present invention, carboxylic acid derivatives of the formula V are used.

In particular, carboxylic acid derivatives of the formula V in which the radicals have the following meanings:
R^{s}, R^{s′} is hydrogen or C₁-C₃₀-alkyl;
T is halogen or O—COR^{s′,}
   are used.

Particular preference is given to using carboxylic acid derivatives of the formula V in which the radicals have the following meanings:
R⁵ is hydrogen or C₁-C₁₈-alkyl, preferably hydrogen or C₁-C₆-alkyl; particularly preferably methyl, ethyl or butyl;
T is halogen, preferably chloride.

Particular preference is likewise given to using carboxylic acid derivatives of the formula V in which the radicals have the following meanings:
R^{s} is 1-decyl, 1-dodecyl, 1-tetradecyl or 1-hexadecyl;
T is halogen, preferably chloride.

Particular preference is given to using carboxylic acid derivatives of the formula V in which the radicals have the following meanings:
R^{s}R^{s′} are each hydrogen or C₁-C₁₈-alkyl, preferably hydrogen or C₁-C₆-alkyl; particularly preferably methyl, ethyl or butyl;
T is OCOR^{s′}.

Extraordinary preference is given to using carboxylic acid derivatives of the formula V in which the radicals R⁵ and R^{5′} have the same meaning (“symmetrical carboxylic anhydrides”).

Particular preference is likewise given to using carboxylic acid derivatives of the formula V in which the radicals have the following meanings:
R^{s} is 1-decyl, 1-dodecyl, 1-tetradecyl or 1-hexadecyl;
T is OCOR^{S}.

In a further embodiment of the present invention, ketenes of the formula VIa are used.

In particular, ketenes of the formula VIa in which the radicals have the following meanings:
R^{t} is hydrogen or C₁-C₁₈-alkyl, preferably hydrogen or C₁-C₆-alkyl; particularly preferably hydrogen, methyl or ethyl; extraordinarily preferably hydrogen;
R^{u} is hydrogen,
   are used.

Particular preference is likewise given to using ketenes of the formula VIa in which the radicals have the following meanings:
R^{t} is 1-decyl, 1-dodecyl, 1-tetradecyl or 1-hexadecyl;
R^{u} is hydrogen.

In a further embodiment of the present invention, diketenes of the formula VIb1 are used.

In particular, diketenes of the formula VIb1 in which the radicals have the following meanings:
R^{t} is hydrogen or C₁-C₁₈-alkyl, preferably hydrogen or C₁-C₆-alkyl, particularly preferably hydrogen, methyl or ethyl, in particular hydrogen;
R^{u} is hydrogen,
   are used.

Particular preference is likewise given to diketenes of the formula VIb1 in which the radicals have the following meanings:
R^{t} is 1-decyl, 1-dodecyl, 1-tetradecyl or 1-hexadecyl;
R^{u} is hydrogen.

In a further embodiment of the present invention, mixed diketenes of the formula VIb2 are used.

In particular, mixed deketenes of the formula VIb2 in which the radicals have the following meanings:
R^{t}, R^{u} are each hydrogen or C₁-C₆-alkyl, preferably hydrogen, methyl or ethyl, in particular hydrogen;
R^{t}, R^{u′} are each hydrogen,
   are used.

In particular, diketenes of the formula VIb2 in which the radicals have the following meanings:
R^{t}, R^{u′} are each 1-decyl, 1-dodecyl, 1-tetradecyl or 1-hexadecyl
R^{t}, R^{u′} are each hydrogen,
   are used.

The acetylation of the silylated cellulose can be carried out in analogy to the methods known to the skilled person. It is, however, also possible to carry out the reaction of the silylated cellulose in an ionic liquid. For that purpose the silylated cellulose is dissolved in an ionic liquid as described at the outset. The concentration of silylated cellulose here can be varied within wide ranges. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution procedure can be carried out at room temperature or with heating, but above the melting point or softening temperature of the ionic liquid, usually at a temperature of from 0 to 200° C., preferably from 20 to 180° C., particularly preferably from 50 to 150° C. However, it is also possible to accelerate dissolution by intensive stirring or mixing or by introduction of microwave or ultrasonic energy or by a combination of these.

The acylating agent is then added to this solution obtained in this way.

The carboxylic acid derivative of the formula V or the ketene of the formula VI can be added as such or as a solution in an ionic liquid or in a suitable solvent. Suitable solvents are, for example, ethers such as diethyl ether, methyl tert-butyl ether, tetrahydrofuran or dioxane, or ketones such as dimethyl ketone or halogenated hydrocarbons such as dichloromethane, trichloromethane or dichloroethane. The amount of solvent used to dissolve the carboxylic acid derivative of the formula V or the ketene of the formula VI should be such that no precipitation of the silylated cellulose occurs when the addition is carried out. Ionic liquids used are preferably those in which the silylated cellulose itself, as described above, is dissolved. If the carboxylic acid derivative of the formula V or the ketene of the formula VI is gaseous, this can be passed as gas into the solution of the silylated cellulose in the ionic liquid.

In a particular embodiment, the carboxylic acid derivative of the formula V or the ketene of the formula VI is added as such.

In a further particular embodiment, the carboxylic acid derivative of the formula V or the ketene of the formula VI is added as a solution in an ionic liquid, with particular preference being given to using the ionic liquid which is also used for dissolving the cellulose.

It is also possible for one or more further solvents to be added to the reaction mixture or be introduced together with the carboxylic acid derivative of the formula V or the ketene of the formula VI. Possible solvents here are solvents which do not adversely affect the solubility of the silylated cellulose, for example aprotic dipolar solvents such as dimethyl sulfoxide, dimethylformamide, dimethylacetamide or sulfolane. Furthermore, nitrogen-comprising bases such as pyridine, etc., can be additionally added.

In a particular embodiment, the reaction mixture comprises, apart from the ionic liquid and any solvent in which the carboxylic acid derivative of the formula V or the ketene of the formula VI has been dissolved, less than 5% by weight, preferably less than 2% by weight, in particular less than 0.1% by weight, based on the total weight of the reaction mixture, of further solvents and/or additional nitrogen-comprising bases.

However, when carboxylic acid derivatives of the formula V in which T=halogen or OCOR^{5′} are used as acylating agents, it can also be advantageous to carry out the acylation in the presence of a tertiary amine, e.g. triethylamine, an aromatic nitrogen base, e.g. pyridine, or mixtures thereof. The tertiary amine, the aromatic nitrogen base or the mixtures thereof are usually used in the stoichiometric ratio. It can sometimes also be advantageous to use an excess or a substoichiometric amount.

When ketenes of the formula VI are used as acylating agent, it is also possible to carry out the acylation according to the invention in the presence of a catalyst. Suitable catalysts here are the alkali metal or alkaline earth metal salts of C₁-C₄-alkanecarboxylic acids or of benzoic acid. Examples are sodium acetate, potassium acetate, sodium propionate, potassium propionate, sodium benzoate or potassium benzoate, preferably sodium acetate. However, it is also possible to use the acids themselves, i.e. the C₁-C₄-alkanecarboxylic acids or benzoic acid. The catalyst is usually used in amounts of up to 10 mol %, preferably up to 8 mol %, based on the ketene of the formula VI.

The reaction is, depending on the ionic liquid used and the carboxylic acid derivative of the formula V used or the ketene of the formula VI used, usually carried out at a temperature from the melting point of the ionic liquid to 200° C., preferably from 20 to 180° C., in particular from 50 to 150° C.

In the case of carboxylic acid derivatives of the formula V or ketenes of the formula VI which are liquid or solid at the reaction temperature, the reaction is usually carried out at ambient pressure. However, it can sometimes also be advantageous to carry it out under superatmospheric pressure, particularly when a volatile carboxylic acid derivative of the formula V or ketene of the formula VI is used. In general, the reaction is carried out in air. However, it is also possible to carry it out under inert gas, i.e., for example, under N₂, a noble gas or mixtures thereof.

In the case of carboxylic acid derivatives of the formula V or ketenes of the formula VI which are gaseous at the reaction temperature, it can be advantageous to carry out the reaction under the autogenous pressure of the reaction mixture at the desired reaction temperature or at a pressure which is higher than the autogenous pressure of the reaction system.

However, it can also be advantageous for the reaction with a carboxylic acid derivative of the formula V or a ketene of the formula VI which is gaseous at the reaction temperature to be carried out under ambient pressure and the gaseous carboxylic acid derivative of the formula V or the ketene of the formula VI to be used in excess.

The amount of acylating agent used, in each case relative to the amount of silylated cellulose used, the reaction time and, if appropriate, the reaction temperature are set as a function of the desired degree of acylation of the silylated cellulose.

For example, if the silylated cellulose (DS 0<3) which is made up of an average of u anhydroglucose units is to be completely acylated, then (3−a)u equivalents of acylating agent are required. Preference is here given to using the stoichiometric amount of acylating agent (n_{acylating agent}/n_{anhydroglucose units}=3−a) or an excess, preferably an excess of up to 1000 mol % based on u. If the silylated cellulose which is made up of an average of u anhydroglucose units is to be partially acylated, then the amount of acylating agent used is usually adapted accordingly (n_{acylating agent}/n_{anhydroglucose units}<3−a). The smaller the ratio n_{acylating agent}/n_{anhydroglucose units}, the smaller the average degree of substitution of the silylated/acylated cellulose under otherwise identical conditions and identical reaction time.

Furthermore, it is possible to stop the acylation reaction when the desired degree of acylation has been reached by separating off the acylated cellulose from the reaction mixture. This can be effected, for example, by addition of an excess of water or another suitable solvent in which the acylated/silylated cellulose is not soluble but the ionic liquid is readily soluble, e.g. a lower alcohol such as methanol, ethanol, propanol or butanol, or a ketone, for example diethyl ketone, etc., or mixtures thereof. The choice of suitable solvent is also determined by the respective degree of substitution and the substituents on the cellulose. Preference is given to using an excess of water or methanol.

The reaction mixture is usually worked up by precipitating the acylated/silylated cellulose as described above and filtering off the acylated/silylated cellulose. However, it is also possible to carry out the separation by centrifugation. The ionic liquid can be recovered from the filtrate or the centrifugate by conventional methods, by distilling off the volatile components, e.g. the precipitant or excess acylating agent (or reaction products and/or hydrolysis products of the acylating agent), etc. The ionic liquid which remains can be reused in the process of the invention.

However, it is also possible to introduce the reaction mixture into water or into another suitable solvent in which the acylated/silylated cellulose is not soluble but the ionic liquid is readily soluble, e.g. a lower alcohol such as methanol, ethanol, propanol or butanol or a ketone, for example diethyl ketone, etc., or mixtures thereof and, depending on the embodiment, obtain, for example, fibers, films of acylated/silylated cellulose. The choice of suitable solvent is also determined by the respective degree of substitution and the substituents on the cellulose. The filtrate is worked up as described above.

Furthermore, it is possible to stop the acylation reaction when the desired degree of acylation has been reached by cooling the reaction mixture and working it up. The work-up can be carried out by the methods indicated above.

The acylation reaction can also be stopped by removing acylating agent still present from the reaction mixture by distillation, stripping or extraction with a solvent which forms two phases with the ionic liquid at a given point in time.

In a further embodiment of the present invention, two or more acylating agents are used. In this case, it is possible to use a mixture of two (or more) carboxylic acid derivatives of the formula V or ketenes of the formula VI in a manner analogous to the above procedure. However, it is also possible firstly to carry out the reaction to a DS=a′(a<a′<3) using the first acylating agent and then carry out the reaction to a DS=b, where a′<b≦3, using a second acylating agent.

In this embodiment, acylated/silylated celluloses which bear two (or more) different acyl radicals (as a function of the acylating agent used) are obtained.

If the ionic liquid is circulated, the ionic liquid is, in one embodiment, purified, for example freed of the precipitant, any further solvents which have been added, hydrolysis and degradation products of the acylating agent, etc., and reused. In a further embodiment, the ionic liquid which comprises up to 15% by weight, preferably up to 10% by weight, in particular up to 5% by weight, of precipitant(s), etc., as described above, can be used again. However, it may in this case sometimes be necessary, for example when the precipitant bears free hydroxy groups, to free the ionic liquid of precipitant still present, etc., for example by distilling off the precipitant still present, etc., or using an appropriate excess of acylating agent.

The process can be carried out batchwise, semicontinuously or continuously.

In one further embodiment the cellulose according to the present invention is silylated in an ionic liquid, and the resulting silylated cellulose is not isolated but instead subjected directly to the acylation as described above.

The following examples illustrate the invention.

### Preliminary Remark:

Avicel PH 101 (microcrystalline cellulose) and/or cotton linters (DP 3250) were dried overnight at 105° C. and 0.05 mbar.

The ionic liquids were dried overnight at 120° C. and 0.05 mbar while stirring, unless indicated otherwise.

The average degree of substitution DS of the silylated cellulose was determined by means of IR-spectroscopic methods, unless indicated otherwise.

### Abbreviations:

BMIM Ac 1-butyl-3-methylimidazolium acetate
BMIM benzoate 1-butyl-3-methylimidazolium benzoate
BMIM Cl 1-butyl-3-methylimidazolium chloride
BMIM SCN 1-butyl-3-methylimidazolium thiocyanate
BMIM Prop 1-butyl-3-methylimidazolium propionate
BMMIM Cl 1-butyl-2,3-methylimidazolium chloride
BzMIM Cl 1-benzyl-3-methylimidazolium chloride
EMIM Ac 1-ethyl-3-methylimidazolium acetate
EMIM DEP 1-ethyl-3-methylimidazolium diethylphosphate
EMIM SCN 1-ethyl-3-methylimidazolium thiocyanate
HMDS hexamethyldisilazane

### NOBA N,O-bistrimethylsilylacetamide

TDMSA thexyldimethylsilylamine
TMSDA trimethylsilylacetamide
AGU anhydroglucose unit
DS average degree of substitution
IL ionic liquid
EA elemental analysis (in the determination of the DS)
NMR ¹H-NMR method (for determining the DS)

### EXAMPLE 1

### General Method

The ionic liquid (about 10 ml) was placed under dry nitrogen in a 100 ml two-neck flash provided with reflux condenser, Avicel PH 101 (about 1.0 g) was added and the mixture was heated to 100° C. while stirring. After a clear solution had been obtained, firstly 0.02 g of saccharine and subsequently the HMDS^{a}) were added. After stirring at 100° C. for 16 hours, the reaction mixture was cooled and introduced into 200 ml of methanol at room temperature while stirring vigorously. The precipitate which formed was filtered off with suction and washed three times with 20 ml each time of methanol. The product obtained in this way was dried to constant weight at 60° C. under reduced pressure for 14 hours.
a) When the solubility limit of the silylating agent in the ionic liquid was exceeded (HMDS about 1% w/w in BMIM Cl), a second phase was initially formed but the phase of the silylating agent was consumed during the course of the reaction.

The results obtained according to this general method are summarized in table 1 below.

TABLE 1

| | | | | | | Solubility of | |
|---|---|---|---|---|---|---|---|
| | Amount | HMDS | n_{(AGUs)}:n_{(HMDS)} | Yield [% of | | the product in | |
| IL | [ml] | [mmol] | [mol/mol] | theory] | DS | Toluene | THF |
| BMMIM Cl | 11 | 6.8 | 1:0.98 | 81 | 1.2 | + | + |
| EMIM SCN | 10 | 6.2 | 1:1.01 | 66 | 1.0 | − | − |
| BMIM SCN | 10 | 6.2 | 1:0.95 | 87 | 0.5 | − | − |
| BMIM Cl | 11 | 30.9 | 1:4.64 | 51 | 2.2 | + | + |
| BMIM Ac | 12 | 30.9 | 1:4.61 | 96 | 2.9 | − | − |
| EMIM Ac | 11 | 30.9 | 1:4.61 | 85 | 2.9 | − | − |
| BzMIM Cl | 12 | 30.9 | 1:4.61 | 75 | 2.4 | + | + |
| BMIM SCN | 10 | 30.9 | 1:4.61 | 74 | 2.8 | + | + |
| EMIM SCN | 10 | 30.9 | 1:4.61 | 74 | 2.7 | + | + |
| BMMIM Cl | 10 | 31.0 | 1:4.63 | 68 | 2.8 | + | + |
| BMIM Cl | 10 | 31.0 | 1:5.0 | 66 | 2.7 | + | + |
| BMIM | 10 | 12.4 | 1:2.0 | 83 | 2.9 | − | − |
| benzoate | | | | | | | |
| BMIM | 10 | 6.8 | 1:1.1 | 68 | 2.1 | + | + |
| benzoate | | | | | | | |
| BMIM | 10 | 3.7 | 1:0.6 | 94 | 0.2 | − | − |
| benzoate | | | | | | | |
| BMIM Cl | 10 | 13.6 | 1:2.2 | 82 | 2.2 | + | + |
| BMIM Ac | 11 | 14.9 | 1:2.3 | 94 | 2.9^{b)} | | |
| BMIM Cl | 11 | 14.9 | 1:2.1 | 82 | 2.5^{b)} | | |
| BMIM Prop | 11 | 3.5 | 1:0.6 | 80 | 1.0 | | |
| BMIM Prop | 11 | 7.4 | 1:1.2 | 88 | 2.2 | | |
| BMIM Prop | 11 | 9.9 | 1:1.5 | 55 | 3.0^{b)} | | |
| EMIM DEP | 11 | 3.8 | 1:0.6 | 96 | 0.9 | | |
| EMIM DEP | 11 | 6.2 | 1:1.1 | 91 | 2.3 | | |
| EMIM DEP | 11 | 9.9 | 1:1.54 | 92 | 2.6 | | |

^{b)}The DS was determined by NMR spectroscopy.

### EXAMPLE 2

Silylcelluloses were prepared by the general method described in example 1 with the silylating agent being varied. The results obtained are summarized in table 2 below.

TABLE 2

| | | | | Yield | |
|---|---|---|---|---|---|
| | Amount | | n_{(AGUs)}:n_{(HMDS)} | [% of | |
| IL | [ml] | Silylating agent | [mol/mol] | theory] | DS |
| BMIM Cl | 10 | Trimethyl- | 1:3.5 | 72 | 2.6 |
| | | silyldiethylamine | | | |
| BMIM Ac | 10 | Trimethyl- | 1.3.8 | 76 | 2.9 |
| | | silyldiethylamine | | | |
| BMIM Cl | 10 | NOBA | 1:1.9 | 83 | 2.5 |
| BMIM Ac | 10 | NOBA | 1:1.8 | 78 | 2.9 |
| BMIM Cl | 10 | NOBA | 1:0.6 | 91 | 0.5 |
| BMIM Cl | 10 | NOBA | 1:1.3 | 74 | 2.5 |
| BMIM Cl | 10 | NOBA | 1:0.7 | 72 | 1.5 |

### EXAMPLE 3

11 ml of BMIM Cl which had previously been dried to constant weight at 100° C. in a high vacuum were placed under dry argon in a 100 ml two-neck flask provided with reflux condenser, 1.17 g of Avicel PH 101 was added at 100° C. and the mixture was stirred until a clear solution was obtained. After addition of 0.021 g of saccharin and 2.4 g of HMDS, the mixture was stirred at 100° C. for another 16 hours, with precipitation of a solid product on the IL commencing after about 1 hour. The reaction mixture was subsequently cooled and introduced into 200 ml of methanol at room temperature while stirring vigorously. The precipitate was filtered with suction and washed three times with 20 ml each time of methanol. The product obtained in this way was dried to constant weight at 60° C. under reduced pressure for 14 hours. This gave 2.06 g of a white solid (83% of theory) which has an average degree of substitution of 2.2 (determined by NMR spectroscopy).

### EXAMPLE 4

11 ml of BMIM Cl which had previously been dried to constant weight at 120° C. in a high vacuum was placed under dry argon in a 100 ml two-neck flask provided with reflux condenser, 1.02 g of Avicel PH 101 was added at 120° C. and the mixture was stirred until a clear solution was obtained. After addition of 0.021 g of saccharine, 2.4 g of HMDS and 20 ml of toluene, the mixture was stirred at 120° C. for another 16 hours. After the toluene phase had been separated off, the IL phase was extracted three times with 20 ml each time of toluene. The toluene phases were combined, the solvent was removed under reduced pressure and the residue obtained in this way was dried to constant weight. This gave 1.66 g of a white solid (83% of theory) having an average degree of substitution of 2.2.

No further product could be isolated from the IL phase by dilution with 200 ml of water.

### EXAMPLE 5

1.06 g of Avicel PH 101 was dissolved in 12 ml of EMIM Cl at 120° C., 2.2 g of HMDS and 0.023 g of saccharine were added and the mixture was stirred at 120° C. for 16 hours, with a solid product being precipitated on the IL phase. 20 ml of toluene were subsequently added, the phases were separated and the IL phase was extracted three times with 20 ml each time of toluene. The toluene phases were combined, the solvent was removed under reduced pressure and the residue obtained in this way was dried to constant weight. This gave 1.83 g of a colorless solid (89% of theory) having an average degree of substitution of 2.1.

No further product could be isolated from the IL phase by dilution with 200 ml of water.

### EXAMPLE 6

2.37 g of Avicel PH 101 were dissolved in 20 g of BMIMCl at 80° C., 5.2 g of HMDS and 0.023 g of saccharine were added and the mixture was stirred at 120° C. for 16 hours, with a solid product being precipitated on the IL phase. 20 ml of toluene were subsequently added, the phases were separated and the IL phase was extracted three times with 20 ml each time of toluene. The toluene phases were combined, the solvent was removed under reduced pressure and the residue obtained in this way was dried to constant weight. This gave 3.6 g of a colorless solid (75% of theory) having an average degree of substitution of 2.3.

No further product could be isolated from the IL phase by dilution with 200 ml of water.

### EXAMPLE 7

11 ml of BMIM Cl which had previously been dried to constant weight at 100° C. in a high vacuum were placed under dry argon in a 100 ml two-neck flask provided with reflux condenser, 0.90 g of Avicel PH 101 was added at 100° C. and the mixture was stirred until a clear solution was obtained. After addition of 4.0 g of HMDS, the mixture was stirred at 100° C. for another 16 hours, with precipitation of a solid product on the IL commencing after about 1 hour. The reaction mixture was subsequently cooled and introduced into 200 ml of methanol at room temperature while stirring vigorously. The precipitate was filtered off with suction and washed three times with 20 ml each time of methanol. The product obtained in this way was dried to constant weight at 60° C. under reduced pressure for 14 hours. This gave 1.72 g of a white solid (89% of theory) having an average degree of substitution of 2.5 (determined by NMR spectroscopy).

### EXAMPLE 8

1.02 g of Avicel PH 101 was dissolved in 11 g of BMIM Cl at 100° C., 2.6 g of HMDS were added and the mixture was stirred at 120° C. for 16 hours, with a solid product being precipitated on the IL phase. 20 ml of toluene were subsequently added, the phases were separated and the IL phase was extracted three times with 20 ml each time of toluene. The toluene phases were combined, the solvent was removed under reduced pressure and the residue obtained in this way was dried to constant weight. This gave 1.76 g of a colorless solid (86% of theory) having an average degree of substitution of 2.3.

No further product could be isolated from the IL phase by dilution with 200 ml of water.

### EXAMPLE 9

### General Method

The ionic liquid (about 10 ml) was placed under dry argon in a 100 ml two-neck flask provided with reflux condenser, heated to 100° C. and the biopolymer (about 1.0 g) was added. The mixture is stirred at 100° C. until a clear solution has been obtained (about 2-4 hours). After a clear solution had been obtained, the silylating agent and, if appropriate, a catalyst were added^{c}). After stirring at 100° C. for 16 hours, the reaction mixture was cooled and introduced into 200 ml of methanol at room temperature while stirring vigorously. The precipitate which formed was filtered off with suction and washed three times with 50 ml each time of methanol. The product obtained in this way was dried to constant weight at 60° C. and 0.05 mbar for 14 hours.
c) When the solubility limit of the silylating agent in the ionic liquid was exceeded, a second phase was initially formed but the phase of the silylating agent was consumed during the course of the reaction.

The results obtained according to this general method are summarized in table 3 below.

TABLE 3

| | | | | | | | Yield | |
|---|---|---|---|---|---|---|---|---|
| | Amount | | Amount | | Amount | n_{(OH)}:n_{(reagent)} | [% of | |
| IL | [ml] | Biopolymer | [g] | Reagent | [g] | [mol:mol] | theory] | DS |
| BMIM Cl | 11 | Potato | 0.917 | NOBA | 2.5 | 1:0.73 | 66 | 2.6^{d)} |
| | | starch | | | | | | |
| BMIM Cl | 11 | Chitin | 0.979 | NOBA | 3.6 | 1:1.84 | 86 | 0.9^{e)} |
| BMIM Cl | 10 | Chitosan | 0.937 | NOBA | 3.6 | 1:1.52 | 81 | 1.4^{e)} |
| BMIM Ac | 11 | Potato | 1.07 | NOBA | 2.5 | 1:0.62 | 66 | 2.7^{d)} |
| | | starch | | | | | | |
| BMIM Cl | 11 | Potato | 1.16 | TMSDA^{f)} | 3.0 | 1:0.95 | 84 | 2.6^{d)} |
| | | starch | | | | | | |
| BMIM Ac | 11 | Potato | 1.16 | TMSDA^{f)} | 3.2 | 1:0.95 | 66 | 2.1 |
| | | starch | | | | | | |
| BMIM Ac | 10 | Chitin | 0.97 | TMSDA^{f)} | 3.2 | 1:2.34 | 82 | 0.4^{d)} |
| BMIM Cl | 11 | Potato | 0.943 | HMDS^{f)} | 3.0 | 1:0.86 | 86 | 2.6^{d)} |
| | | starch | | | | | | |
| BMIM Cl | 10 | Chitin | 0.281 | HMDS^{f)} | 2.3 | 1:5.1 | 84 | 0.5^{e)} |
| BMIM Cl | 10 | Chitosan | 0.234 | HMDS^{f)} | 2.4 | 1:4.97 | 85 | 0.4^{e)} |
| BMIM Ac | 11 | Potato | 1.029 | HMDS^{f)} | 2.2 | 1:0.73 | 79 | 1.9 |
| | | starch | | | | | | |

^{d)}The DS was determined by NMR spectroscopy
^{e)}The DS was determined by EA
^{f)}Addition of 0.2 g of saccharine as catalyst

### EXAMPLE 10

### General Method

The ionic liquid (about 10 ml) was placed under dry argon in a 100 ml two-neck flask provided with reflux condenser, heated to 100° C. and AVICEL PH 101 (about 1.0 g) was added. The mixture is stirred at 100° C. until a clear solution has been formed (about 2-4 hours). After a clear solution had been obtained, the TDMSA and if appropriate a catalyst were added^{g)}. After stirring at 100° C. for 16 hours, the reaction mixed was cooled and introduced into 200 ml of methanol at room temperature whilst stirring vigorously. The precipitate formed was filtered off with suction and washed three times with 50 ml each time of methanol. The product obtained in this way was dried to constant weight at 60° C./0.05 mbar for 14 hours.
g) When the solubility limit of the silylating agent in the ionic liquid was exceeded, a second phase was initially formed but the phase of the silylating agent was consumed during the course of the reaction.

The results obtained according to this general method are summarized in table 4 below.

TABLE 4

| | | | | Yield | |
|---|---|---|---|---|---|
| | Amount | TDMSA | n_{(AGUs)}:n_{(TDMSA)} | [% of | |
| IL | [ml] | [mmol] | [mol:mol] | theory] | DS^{h)} |
| BMIM Cl | 11 | 19.4 | 1:3.3 | 87 | 0.9 |
| BMIM Cl | 11 | 6.5 | 1:1 | 92 | 0.4 |
| BMIM Cl | 11 | 11.5 | 1:1.9 | 97 | 0.7 |
| BMIM Cl | 11 | 18.8 | 1:3.1 | 94 | 1.1 |
| BMIM Ac | 11 | 19.4 | 1:3.5 | 80 | 1.3 |
| BMIM Ac | 11 | 7.7ⁱ⁾ | 1:1.3 | 72 | 0.6 |
| BMIM Ac | 11 | 12.7ⁱ⁾ | 1:2.1 | 76 | 1.1 |
| BMIM Prop | 11 | 17.6 | 1:2.9 | 85 | 1.2 |
| BMIM | 11 | 18.4 | 1:3.0 | 85 | 2.1 |
| Benzoate | | | | | |
| EMIM DEP | 11 | 19.3 | 1:3.4 | 83 | 1.9 |

^{h)}the DS was determined by NMR spectroscopy
ⁱ⁾addition of 0.2 g of saccharine as catalyst

### EXAMPLE 11

1.0 g of cotton linters was dissolved in 10 ml of BMIM Cl, containing 200 ppm of water, by stirring at 120° C. for 4 hours (n_{(AGU)}:n_{(H2O)}=55:1). After 2 hours of stirring at 150° C. the mixture was cooled to 80° C., 6.0 g of HMDS were added, and the mixture was stirred at 80° C. for 16 hours. The reaction mixture was then incorporated by stirring into 200 ml of methanol, and the precipitate was filtered off, washed with three times 20 ml of methanol and dried to constant weight at 60° C. and 0.05 mbar. The resulting product was obtained with a yield of 84% of theory and has a DP of 57 (determination by gel permeation chromatography) and a DS of 2.1 (determination by NMR).

### EXAMPLE 12

### General Method

1.0 g of cotton linters was dissolved in 10 ml of BMIM Cl by stirring at 120° C. for 4 hours. Then the amount of water added in table 5 was added and the mixture was heated to 150° C. and stirred at that temperature for the time likewise indicated in table 1. Subsequently it was cooled to 80° C., 6.0 g of HMDS and 25 ml of benzene were added, and the mixture was stirred at 80° C. for 16 hours. It was worked up by one of the following variants:
A: After cooling, the benzene phase was separated off, and the IL phase was extracted with twice 25 ml of benzene. The combined benzene phases were lyophilized.
B: After cooling, the reaction mixture was admixed with 20 ml of cyclohexane, and the upper phase was separated off and lyophilized.

The results obtained according to this general method are summarized in table 5 below.

TABLE 5

| | | | | Yield | | |
|---|---|---|---|---|---|---|
| n_{(AGU)}:n_{(H2O)} | | Time at 150° C. | | [% of | | |
| [mol/mol] | Amount of water | [h] | Work-up | theory] | DP^{j)} | DS^{k)} |
| 2:1 | 0.05 ml (2.9 mmol) | 3 | A | 98 | 26 | 2.2 |
| 2:1 | 0.05 ml (2.9 mmol) | 4 | A | 100 | 15 | 2.1 |
| 2:1 | 0.05 ml (2.9 mmol) | 6 | A | 81 | 11 | 2.2 |
| 1:1.8 | 0.2 ml (11.1 mmol) | 15 | B | 86 | 1 | 4.7 |

^{j)}the DP was determined by gel permeation chromatography
^{k)}the DS was determined by NMR spectroscopy

### EXAMPLE 13

### General Method

A 100 ml two-neck flask with reflux condenser was charged under dry nitrogen with the ionic liquid (about 10 ml), Avicel PH 101 (about 1.0 g) was added, and the mixture was heated with stirring. After a clear solution had been obtained, first 0.02 g of saccharine was added, and subsequently the amount of HMDS indicated in table 6. After 16 hours of stirring at the temperature indicated in table 6, the reaction mixture was cooled and alternatively the reaction mixture was introduced at room temperature into 200 ml of methanol with vigorous stirring, the precipitate which formed was separated off with suction and this precipitate was washed with three times 20 ml of methanol, or the reaction mixture was extracted with toluene and the toluene phase was concentrated. The product thus obtained was dried to constant weight for 14 hours.

The results obtained according to this general method are summarized in table 6 below.

TABLE 6

| | n_{(AGU)}:n_{(HMDS)} | Temperature | |
|---|---|---|---|
| IL | [mol/mol] | [° C.] | DS |
| BMIM Cl | 1:1 | 80 | 0.2 |
| BMIM Cl | 1:2 | 80 | 2.1 |
| BMIM Cl | 1:1 | 100 | 1.1 |
| BMIM Cl | 1:4.6 | 100 | 2.4 |
| BMIM Cl | 1:1 | 120 | 1.0 |
| BMIM Cl | 1:2 | 120 | 2.0 |
| BMMIM Cl | 1:2 | 100 | 2.3 |
| BMMIM Cl | 1.4.6 | 120 | 2.6 |
| BMIM Ac | 1:0.5 | 80 | 0.2 |
| BMIM Ac | 1:1 | 80 | 0.2 |
| BMIM Ac | 1.2.2 | 80 | 2.8 |
| BMIM Ac | 1:2.2 | 100 | 2.8 |
| BMIM Ac | 1:1 | 120 | 1.1 |
| BMIM Ac | 1:2.5 | 120 | 2.7 |
| EMIM Ac | 1:4.6 | 100 | 2.8 |

### EXAMPLE 14

### General Method

1.0 g of cellulose hydrate was stirred in 10 ml of BMIM Cl, containing 200 ppm of water, at 120° C. for 4 hours. The mixture was then heated to 150° C. and stirred at that temperature for the time indicated in table 7. Subsequently the mixture was cooled to 80° C., 6.0 g of HMDS and the mixture was stirred at 80° C. for 16 hours. It was worked up by the following variants:

A: lyophilization
B: extraction with an aromatic solvent

The results obtained according to this general method are summarized in table 7 below.

TABLE 7

| Time at 150° C. | | | |
|---|---|---|---|
| [h] | Work-up | M_{w}^{l)} | DS^{m)} |
| 2 | A | 7750 | 2.3 |
| 15 | B | 770 | 3.8 |

^{l)}the M_{w} was determined by gel permeation chromatography
^{m)}the DS was determined by NMR spectroscopy

1. A process for silylating polysaccharides, oligosaccharides or disaccharides or derivatives thereof, which comprises dissolving a polysaccharide, oligosaccharide or disaccharide or the corresponding derivative in at least one ionic liquid and reacting it with a silylating agent.

2. The process according to claim 1, wherein a polysaccharide or a derivative thereof is used as the polysaccharide, oligosaccharide or disaccharide or derivative thereof.

3. The process according to claim 2, wherein cellulose or a cellulose derivative is used as the polysaccharide or derivative thereof.

4. The process according to claim 3, wherein cellulose is used as the polysaccharide or derivative thereof.

5. The process according to claim 1, wherein the ionic liquid or mixture thereof is selected from among the compounds of the formula I,
[A]ₙ⁺[Y]ⁿ⁻ (I)
where
n is 1, 2, 3 or 4;
[A]⁺ is a quaternary ammonium cation, an oxonium cation, a sulfonium cation or a phosphonium cation; and
[Y]ⁿ⁻ is a monovalent, divalent, trivalent or tetravalent anion;
or
the compounds of the formula II
[A¹]⁺[A²]⁺[Y]ⁿ⁻ (IIa)
where n=2;
[A¹]⁺[A²]⁺[A³]⁺[Y]ⁿ⁻ (IIb)
where n=3; or
[A¹]⁺[A²]⁺[A³]⁺[A⁴]⁺[Y]ⁿ⁻ (IIIc)
where n=4,
where
[A¹]⁺, [A²]⁺, [A³]⁺ and [A⁴]⁺ are selected independently from among the groups mentioned for [A]⁺; and
[Y]ⁿ⁻ is as defined above.

6. The process according to claim 5, wherein [A]⁺ is a cation selected from among the compounds of the formulae (IIIa) to (IIIy) 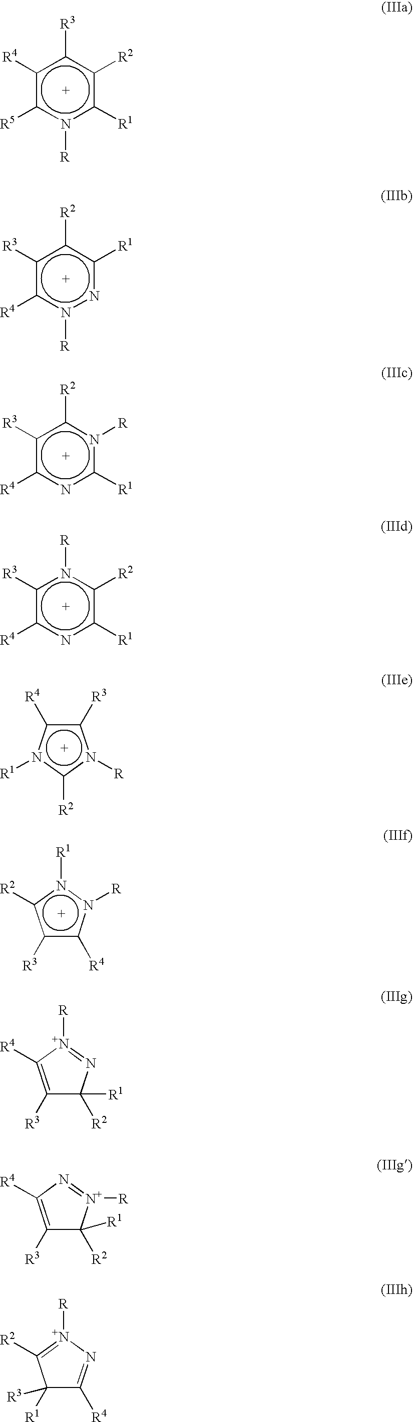 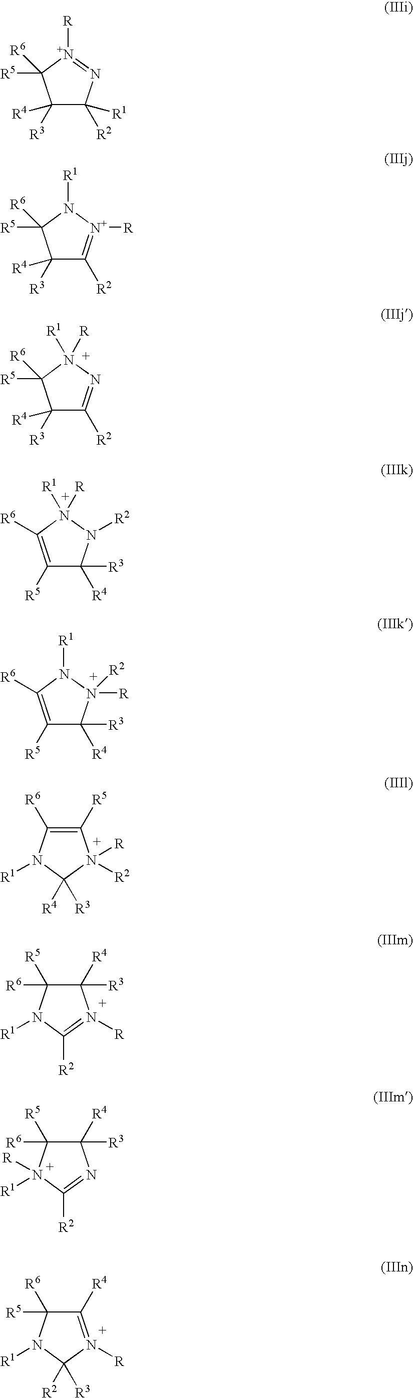 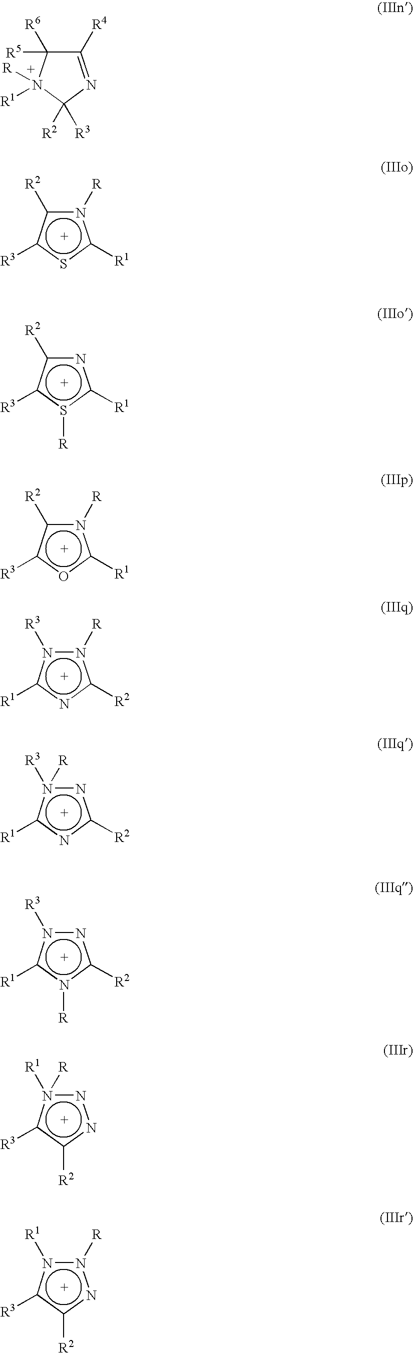 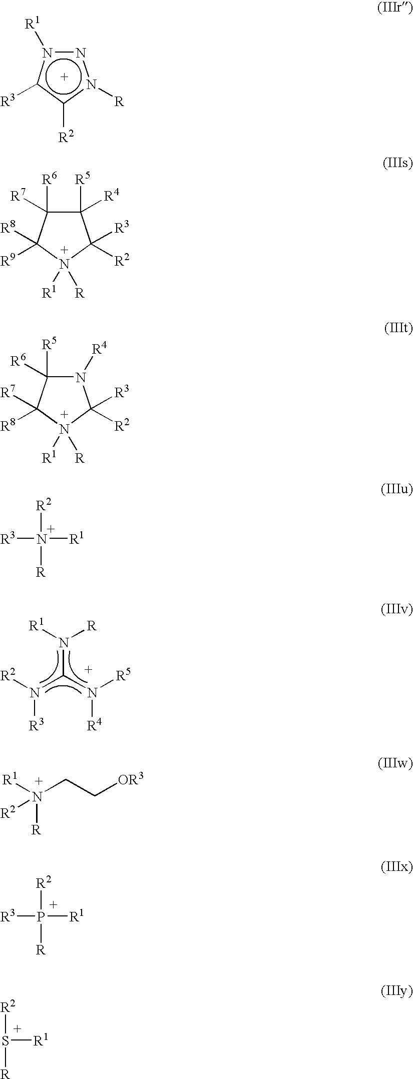
and oligomers comprising these structures, where
the radical R is hydrogen or a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (II) mentioned above are additionally able to be halogen or a functional group; or
two adjacent radicals from the group consisting of R¹ to R⁹ may together also form a divalent, carbon-containing organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups;
where, when IIIw is III, then R³ is not hydrogen.

7. The process according to claim 5, wherein [Y]ⁿ⁻ is an anion selected from
the group of halides and halogen-containing compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae: 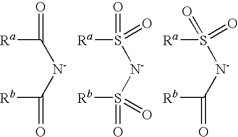
and the group of methides of the general formula: 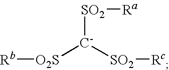
where the radicals R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-containing heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by suitable functional groups, aryl, alkyl, aryloxy, alkyloxy, halogen, heteroatoms and/or heterocycles.

8. The process according to claim 5, wherein [A]⁺ is a cation selected from the group of the compounds IIIa, IIIe, IIIf; IIIg, IIIg′, IIIh, IIIi, IIIj, IIIj′, IIIk, IIIk′, IIIl, IIIm, IIIm′, IIIn and IIIn′.

9. The process according to claim 5, wherein [A]⁺ is a cation selected from the group of the compounds IIIa, Ille and IIIf.

10. The process according to claim 5, wherein [Y]ⁿ⁻ is an anion selected from the group of halides and halogen-containing compounds, the group of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄⁻.

11. The process according to, claim 1, wherein the silylating agent comprises a compound of the formula IV 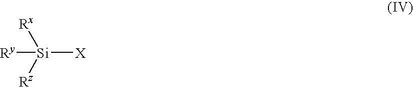
where the radicals have the following meanings:
R^{x}, R^{y}, R^{z} are each C₁-C₃₀-alkyl, C₂-C₃₀-alkenyl, C₂-C₃₀-alkynyl, C₃-C₁₂-cycloalkyl, C₅-C₁₂-cycloalkenyl or aryl, where the six radicals may optionally be substituted; and
X is halogen, NH₂, imidazol-1-yl, di-(C₁-C₆-alkyl)amine, NH—SiR^{x}R^{y}R^{z}, NH—CO—NH—SiR^{x}R^{y}R^{z}, NHCO—(C₁-C₆-alkyl), N(C₁-C₆-alkyl)-CO—(C₁-C₆-alkyl), N(C₁-C₆-alkyl)-CO—(C₁-C₆-haloalkyl), O—SO₂—(C₁-C₆-alkyl), O—SO₂—(C₁-C₆-haloalkyl), O—C(═N—SiR^{x}R^{y}R^{z})—(C₁-C₆-alkyl) or O—C(═N—SiR^{x}R^{y}R^{z})—(C₁-C₆-haloalkyl).

12. The process according to claim 11, wherein the radicals of the silylating agent of the formula IV have the following meanings:
R^{x}, R^{y}, R^{z} are each C₁-C₃₀-alkyl or aryl, where the radicals may optionally be substituted; and
X is halogen, imidazol-1-yl, di-(C₁-C₆-alkyl)amine, NH—SiR^{u}R^{v}R^{w}, O—C(═N—SiR^{x}R^{y}R^{z})—(C₁-C₆-alkyl) or O—C(═N—SiR^{x}R^{y}R^{z})—(C₁-C₆-haloalkyl).

13. The process according to claim 12, wherein the radicals of the silylating agent of the formula IV have the following meanings:
R^{x}, R^{y′}, R^{z′} are each C₁-C₆-alkyl or phenyl; and
X is chlorine, di-(C₁-C₄-alkyl)amine, NH—SiR^{x}R^{y}R^{z}, O—C(═N—SiR^{x}R^{y}R^{z})—(C₁-C₄-alkyl) or O—C(═N—SiR^{x}R^{y}R^{z})—(C₁-C₄-haloalkyl).

14. The process according to claim 13, wherein the radicals of the silylating agent of the formula IV have the following meanings:
R^{X}, R^{y′}, R^{z′} are each C₁-C₆-alkyl; and
X is di-(C₁-C₄-alkyl)amine, NH—SiR^{x}R^{y}R^{z}, O—C(═N—SiR^{x}R^{y}R^{z})—(C₁-C₄-alkyl) or O—C(═N—SiR^{x}R^{y}R^{z})—(C₁-C₄-haloalkyl).

15. The process according to claim 1, wherein the concentration of polysaccharide, oligosaccharide or disaccharide or derivative thereof in the ionic liquid is in the range from 0.1 to 50% by weight, based on the total weight of the solution.

16. The process according to claim 1, wherein the reaction is carried out at a temperature from the melting point of the ionic liquid to 200° C.

17. The process according to claim 1, wherein the silylation of the polysaccharide is quenched by addition of a solvent in which the silylated polysaccharide is not soluble.

18. A process for silylating poly-, oligo- or disaccharides, or derivatives thereof, wherein a poly- or oligosaccharide, or the corresponding derivative, is dissolved in at least one ionic liquid and the resulting solution
Step A) is treated with at least one acid, optionally with an addition of water, (step A1), or
optionally with an addition of water, at elevated temperature (step A2), and
Step B) the resulting poly-, oligo- or disaccharide, or derivative thereof, whose DP is lower than that of the poly- or oligosaccharide employed, is reacted with a silylating agent, according to claim 1.

19. A process for acylating silylated poly-, oligo- or disaccharides, or derivatives thereof, wherein a poly-, oligo- or disaccharide, or the corresponding derivative, is dissolved in at least one ionic liquid, in a first step, reacted with a silylating agent according to claim 1, and subsequently acylated.

20. The process according to claim 19, in which not only the reaction of the poly-, oligo- or disaccharide, or a derivative thereof, with the silylating agent but also the subsequent acylation are carried out in an ionic liquid, as described in claim 5.
